(19) United States
(12) Patent Application Publication
(10) Pub. No.: US 2011/0271246 A1
(43) Pub. Date: Nov. 3, 2011

(54) SOFTWARE DEVELOPMENT SUPPORT TOOL

(75) Inventor: Yutaka FUJIHARA, Kyoto (JP)

(73) Assignee: Panasonic Corporation, Osaka (JP)

(21) Appl. No.: 13/183,026

(22) Filed: Jul. 14, 2011

Related U.S. Application Data
(63) Continuation of application No. PCT/JP2009/005161, filed on Oct. 5, 2009.

(30) Foreign Application Priority Data
Feb. 26, 2009 (JP) 2009-044687

(51) Int. Cl. G06F 9/44

(52) U.S. Cl. 717/104; 717/120

(57) ABSTRACT

A software development support tool includes a software model reader configured to read a software model, a software model design intent extractor configured to extract a developer's design intent described in the software model, a source code generator configured to output a source code based on generation rule information, a source code reader configured to read a source code, a source code design intent extractor configured to extract a developer's design intent described in the source code, a software model generator configured to output a software model based on generation rule information, a rule database section configured to accumulate and manage portions of rule information, a database update manager, and a rule modifier.

### CROSS-REFERENCE TO RELATED APPLICATIONS

This is a continuation of PCT International Application PCT/JP2009/005161 filed on Oct. 5, 2009, which claims priority to Japanese Patent Application No. 2009-044687 filed on Feb. 26, 2009. The disclosures of these applications including the specifications, the drawings, and the claims are hereby incorporated by reference in their entirety.

### BACKGROUND

The present disclosure relates to tools for supporting techniques of developing software by generating a software model from a source code.

As a conventional software development support tool which generates a software model from a source code, there is a known technique capable of automatically generating a program structure diagram from an actual source program (see Japanese Patent Publication No. S63-273131).

In the conventional software development support tool, the source code is literally and formally converted into a model, and it is difficult to reflect a developer's design intent in the model. When a model description does not contain a developer's design intent, which is a key element of design information, it is difficult to subsequently add and modify a description in the model. At present, a code has to be manually converted into a model when design intent needs to be reflected in a model description. Therefore, the conversion of huge existing software assets into model descriptions is inefficient and difficult in terms of size and cost.

### SUMMARY

The present disclosure describes implementations of a software design technique which is mainly directed to a software model and is used to automatically generate a software model containing a developer's design intent from an existing source code.

An example software development support tool includes a software model reader configured to receive a software model described by a developer and output information required for automatic generation of a source code as software model information, a software model design intent extractor configured to receive the software model information, and software model design intent extraction rule information which describes a rule for extracting design intent of the developer described in the software model, and extract and output the design intent of the developer described in the software model as software model design intent information, a source code generator configured to receive the software model information, the software model design intent information, and source code generation rule information which describes a rule for generating the source code from the software model, and output the source code, a source code reader configured to receive a source code and output information required for automatic generation of a software model as source code information, a source code design intent extractor configured to receive the source code information, and source code design intent extraction rule information which describes a rule for extracting design intent of the developer described in the source code, and extract and output the design intent of the developer described in the source code as source code design intent information, a software model generator configured to receive the source code information, the source code design intent information, and software model generation rule information which describes a rule for generating the software model from the source code, and output the software model, a rule database section configured to accumulate, in a database, the software model generation rule information, the software model design intent extraction rule information, the source code generation rule information, and the source code design intent extraction rule information, and manage the database, a database update manager configured to manage updating of contents of the rule database section, and a rule modifier configured to receive the software model information, the software model generation rule information, the software model design intent extraction rule information, the software model design intent information, the source code information, the source code generation rule information, the source code design intent extraction rule information, and the source code design intent information, and instruct the database update manager to modify the software model generation rule information, the software model design intent extraction rule information, the source code generation rule information, and the source code design intent extraction rule information to reflect intent of the developer.

According to the software development support tool of the present disclosure, a software model containing a developer's design intent can be generated from an existing source code, and therefore, a software design technique mainly directed to software models can be easily provided. Also, when software development is newly performed using a software design technique mainly directed to software models, design is started from an abstract software model, an initial generated source code is modified by a developer, a software model is generated, and the software model is combined with the abstract software model. By iterating this process, a more specific software model can be easily developed.

According to the software development support tool of the present disclosure, a software design technique mainly directed to software models can be easily obtained.

### BRIEF DESCRIPTION OF THE DRAWINGS

FIG. 1 is a configuration diagram of a software development support tool according to an embodiment of the present disclosure.

FIG. 2 is an operational flow chart of a software model reader of the embodiment of the present disclosure.

FIG. 3 is an operational flow chart of a process of analyzing a description content of a description element in the software model reader of the embodiment of the present disclosure.

FIG. 4 is an operational flow chart of a process of determining a description position of a description element in the software model reader of the embodiment of the present disclosure.

FIG. 5 is an operational flow chart of a process of scanning link elements of a description element in the software model reader of the embodiment of the present disclosure.

FIG. 6 is an operational flow chart of a source code generator in the embodiment of the present disclosure.

FIG. 7 is an operational flow chart of a software model design intent extractor in the embodiment of the present disclosure.

FIG. 8 is an operational flow chart of a link pattern analysis process of the software model design intent extractor in the embodiment of the present disclosure.

FIG. 9 is an operational flow chart of a process of calculating a link distance to a link destination element, of the software model design intent extractor in the embodiment of the present disclosure.

FIG. 10 is an operational flow chart of a process of calculating a link distance to a link source element, of the software model design intent extractor in the embodiment of the present disclosure.

FIG. 11 is an operational flow chart of a link distance value updating process of the software model design intent extractor in the embodiment of the present disclosure.

FIG. 12 is an operational flow chart of a link source distance value updating process of the software model design intent extractor in the embodiment of the present disclosure.

FIG. 13 is an operational flow chart of a link intent matching process of the software model design intent extractor in the embodiment of the present disclosure.

FIG. 14 is an operational flow chart of a database update manager in the embodiment of the present disclosure.

FIG. 15 is an operational flow chart of a source code design intent extractor in the embodiment of the present disclosure. FIG. 16 is an operational flow chart of a relation pattern analysis process of the source code design intent extractor in the embodiment of the present disclosure.

FIG. 17 is an operational flow chart of a process of calculating a distance to a relation destination block, of the source code design intent extractor in the embodiment of the present disclosure.

FIG. 18 is an operational flow chart of a distance value updating process of the source code design intent extractor in the embodiment of the present disclosure.

FIG. 19 is an operational flow chart of a relation direction updating process of the source code design intent extractor in the embodiment of the present disclosure.

FIG. 20 is an operational flow chart of a relation type setting process of the source code design intent extractor in the embodiment of the present disclosure.

FIG. 21 is an operational flow chart of a description characteristic analysis and setting process of the source code design intent extractor in the embodiment of the present disclosure.

FIG. 22 is an operational flow chart of a design intent matching process of the source code design intent extractor in the embodiment of the present disclosure.

FIG. 23 is an operational flow chart of a rule modifier in the embodiment of the present disclosure.

FIG. 24 is an operational flow chart of a process of extracting a block difference from a difference in source code information, of the rule modifier in the embodiment of the present disclosure.

FIG. 25 is an operational flow chart of a process of adding a rule to source code generation rule information, of the rule modifier in the embodiment of the present disclosure.

FIG. 26 is an operational flow chart of a process of extracting a related description, of the rule modifier in the embodiment of the present disclosure.

FIG. 27 is an operational flow chart of a process of specifying a block and calculating an element ID, of the rule modifier in the embodiment of the present disclosure.

FIG. 28 is an operational flow chart of a generated code template modification process of the rule modifier in the embodiment of the present disclosure.

FIG. 29 is an operational flow chart of a software model design intent extraction rule information addition process of the rule modifier in the embodiment of the present disclosure.

FIG. 30 is an operational flow chart of a process of extracting an element difference of software model information, of the rule modifier in the embodiment of the present disclosure.

FIG. 31 is an operational flow chart of a process of adding a rule to software model generation rule information, of the rule modifier in the embodiment of the present disclosure.

FIG. 32 is an operational flow chart of a process of specifying an element ID and calculating a block ID, of the rule modifier in the embodiment of the present disclosure.

FIG. 33 is an operational flow chart of a generated software model template modification process of the rule modifier in the embodiment of the present disclosure.

FIG. 34 is an operational flow chart of a source code design intent extraction rule information addition process of the rule modifier in the embodiment of the present disclosure.

FIG. 35 is an operational flow chart of a source code reader in the embodiment of the present disclosure.

FIG. 36 is an operational flow chart of a process of setting a relation destination ID in a relation list, of the source code reader in the embodiment of the present disclosure.

FIG. 37 is a diagram showing example software model information in the embodiment of the present disclosure.

FIG. 38 is a diagram showing example software model design intent information in the embodiment of the present disclosure.

FIG. 39 is a diagram showing example software model design intent extraction rule information in the embodiment of the present disclosure.

FIG. 40 is a diagram showing example source code generation rule information in the embodiment of the present disclosure.

FIG. 41 is a diagram showing example source code information in the embodiment of the present disclosure.

FIG. 42 is a diagram showing example source code design intent information in the embodiment of the present disclosure.

FIG. 43 is a diagram showing example source code design intent extraction rule information in the embodiment of the present disclosure.

FIG. 44 is a diagram showing an example relation type information table in the embodiment of the present disclosure.

FIG. 45 is a diagram showing example software model generation rule information in the embodiment of the present disclosure.

FIG. 46 is an operational flow chart of a software model generator in the embodiment of the present disclosure.

FIG. 47 is a diagram showing an example software model in the embodiment of the present disclosure.

FIG. 48 is a configuration diagram of a system which includes the software development support tool of the embodiment of the present disclosure and an input/output section.

### DETAILED DESCRIPTION

Embodiments of the present disclosure will be described hereinafter with reference to the accompanying drawings.

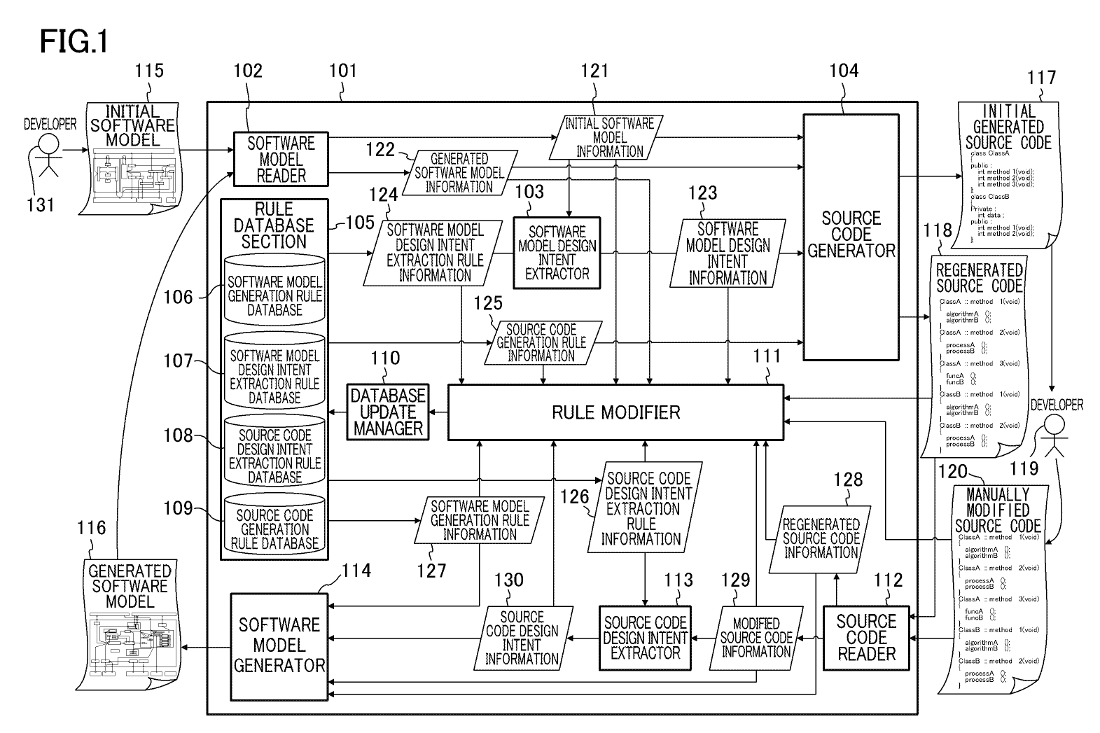

FIG. 1 is a configuration diagram of a software development support tool according to an embodiment of the present disclosure. In FIG. 1, a reference character 101 indicates the software development support tool of the embodiment of the present disclosure. In the software development support tool 101, a software model reader 102 receives an initial software model 115 which is created by a developer 131 or a generated software model 116, converts a description of a graphic software model into data which can be easily processed by a computer, and outputs the data as initial software model information 121 or generated software model information 122. A software model design intent extractor 103 receives the initial software model information 121 or the generated software model information 122, and software model design intent extraction rule information 124 which stores a rule for extracting the design intent of the developer contained in the software model, and outputs software model design intent information 123 which is data of the design intent contained in the software model. A source code generator 104 receives the initial software model information 121, the software model design intent information 123, and source code generation rule information 125 which stores a rule for generating a source code, and outputs an initial generated source code 117 corresponding to the initial software model 115 or a regenerated source code 118 corresponding to the generated software model 116. A rule database section 105 includes a software model generation rule database 106 which stores a rule for generating a software model from a source code, a source code generation rule database 109 which stores a rule for generating a source code from a software model, a software model design intent extraction rule database 107 which stores a rule for extracting a developer's design intent contained in a software model, and a source code design intent extraction rule database 108 which stores a rule for extracting a developer's design intent contained in a source code.

A rule modifier 111 receives the initial software model information 121, the generated software model information 122, the software model design intent information 123, the software model design intent extraction rule information 124, the source code generation rule information 125, modified source code information 129, regenerated source code information 128, software model generation rule information 127, source code design intent extraction rule information 126, and source code design intent information 130, and modifies the contents of the four databases 106-109 included in the rule database section 105 to modify conversion from a software model to a source code and conversion from a source code to a software model so that the conversion fits with a developer's intent to a greater extent. A database update manager 110 instructs the rule database section 105 to modify the database in response to an instruction from the rule modifier 111. A source code reader 112 receives and converts a manually modified source code 120 which is created or modified by a developer 119, into data which can be easily processed by a computer, and outputs the data as the regenerated source code information 128 or the modified source code information 129. A source code design intent extractor 113 receives the modified source code information 129 or the regenerated source code information 128, and the source code design intent extraction rule information 126 which stores a rule for extracting a developer's design intent contained in a source code, and outputs the source code design intent information 130 which is data of a design intent contained in a source code. A software model generator 114 receives the modified source code information 129 or the regenerated source code information 128, the source code design intent information 130, and the software model generation rule information 127 which stores a rule for generating a software model, and outputs the generated software model 116 corresponding to the manually modified source code 120 or the regenerated source code 118.

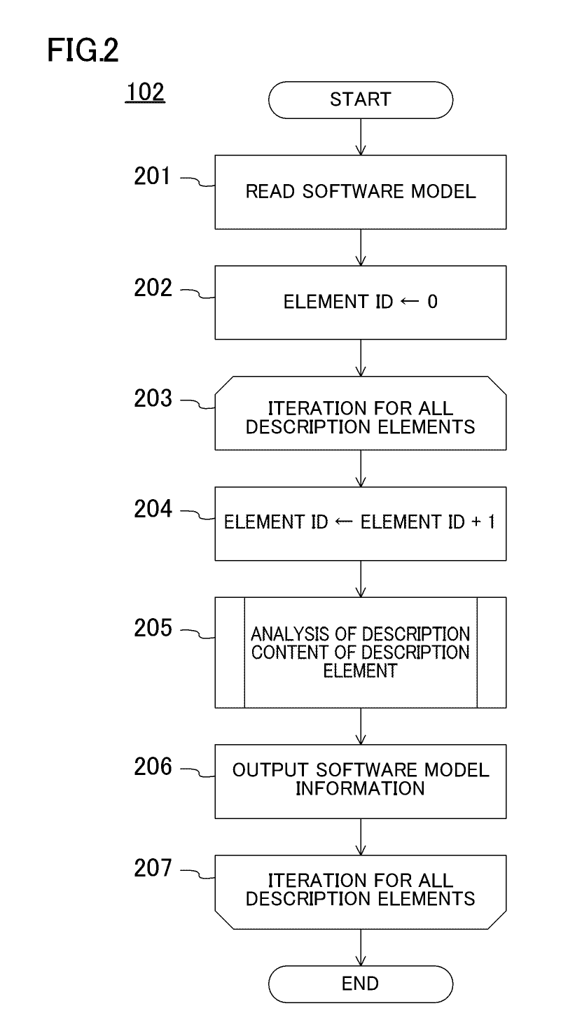

FIG. 2 shows a process flow of the software model reader 102. The software model reader 102 receives the initial software model 115 created by the developer 131 or the generated software model 116, converts a description of a graphic software model into data which can be easily processed by a computer, and outputs the data as the initial software model information 121 or the generated software model information 122. Initially, the initial software model 115 described by the developer 131 or the generated software model 116 is read (201). Next, an element ID is set to zero (202). Next, iteration is started for all description elements described in the software model (203). Next, the value of the element ID is incremented by one (204). Next, contents of a description of the description element are analyzed in order to output software model information (205). Next, a result of the analysis in step 205 is output as the initial software model information 121 or the generated software model information 122 (206). Next, control returns to step 204 to begin a new iteration. Step 207 indicates an end point of the iterative process beginning at step 203.

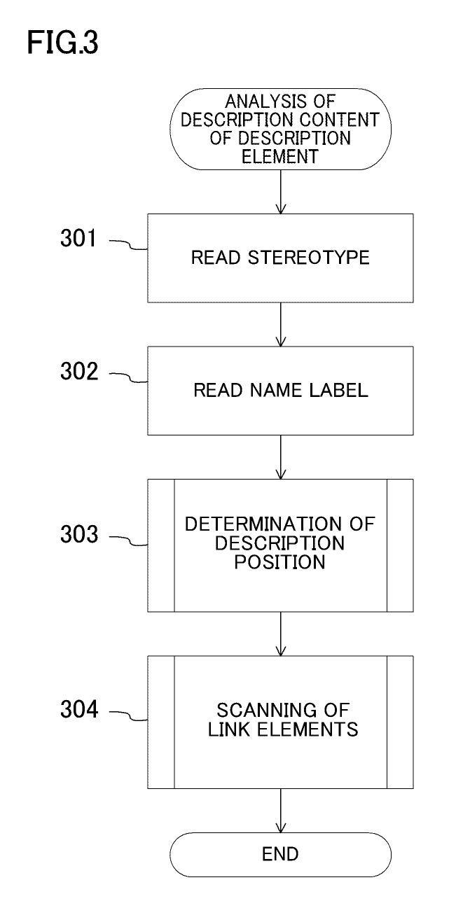

FIG. 3 shows a process flow of a subroutine of analyzing a description content of a description element, which is called in step 205 in the process flow of the software model reader 102 of FIG. 2. Initially, a stereotype of a currently processed description element is read (301). Next, a name label of the currently processed description element is read (302). Next, a description position of the currently processed description element is determined (303). Next, another description element or elements linked to the currently processed description element are scanned (304).

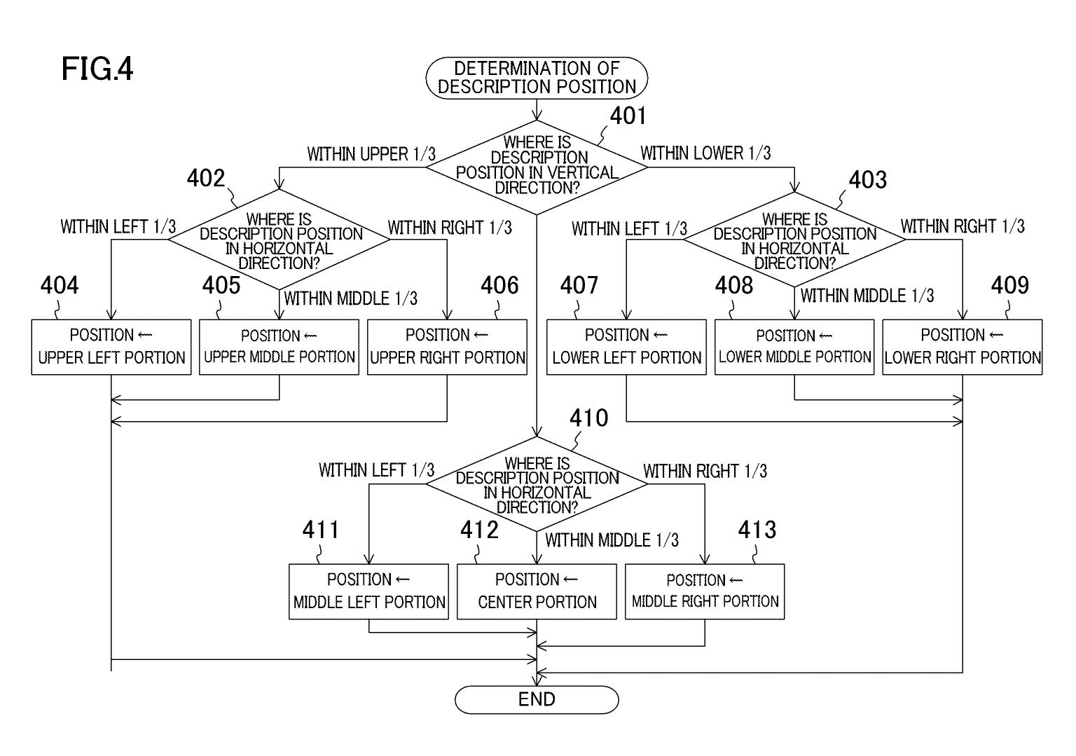

FIG. 4 shows a process flow of a description position determination subroutine which is called in step 303 from the description element description content analysis subroutine of FIG. 3. Initially, a description position in the vertical direction of an element whose a description position is to be determined is determined (401). If the description position is located within upper ⅓, a description position in the horizontal direction is determined (402). If the description position is located within left ⅓ in the horizontal direction, the description position is set to “upper left portion” (404). If the description position is located within middle ⅓, the description position is set to “upper middle portion” (405). If the description position is located within right ⅓ in the horizontal direction, the description position is set to “upper right portion” (406). If step 401 determines that the description position is located within lower ⅓, a description position in the horizontal direction is determined (403). If the description position is located within left ⅓ in the horizontal direction, the description position is set to “lower left portion” (407). If the description position is located within middle ⅓, the description position is set to “lower middle portion” (408). If the description position is located within right ⅓ in the horizontal direction, the description position is set to “lower right portion” (409). If step 401 determines that the description position is not located within upper ⅓ or lower ⅓, a description position in the horizontal direction is determined (410). If the description position is located within left ⅓ in the horizontal direction, the description position is set to “middle left portion” (411). If the description position is located within middle ⅓, the description position is set to “center portion” (412). If the description position is located within right ⅓ in the horizontal direction, the description position is set to “middle right portion” (413).

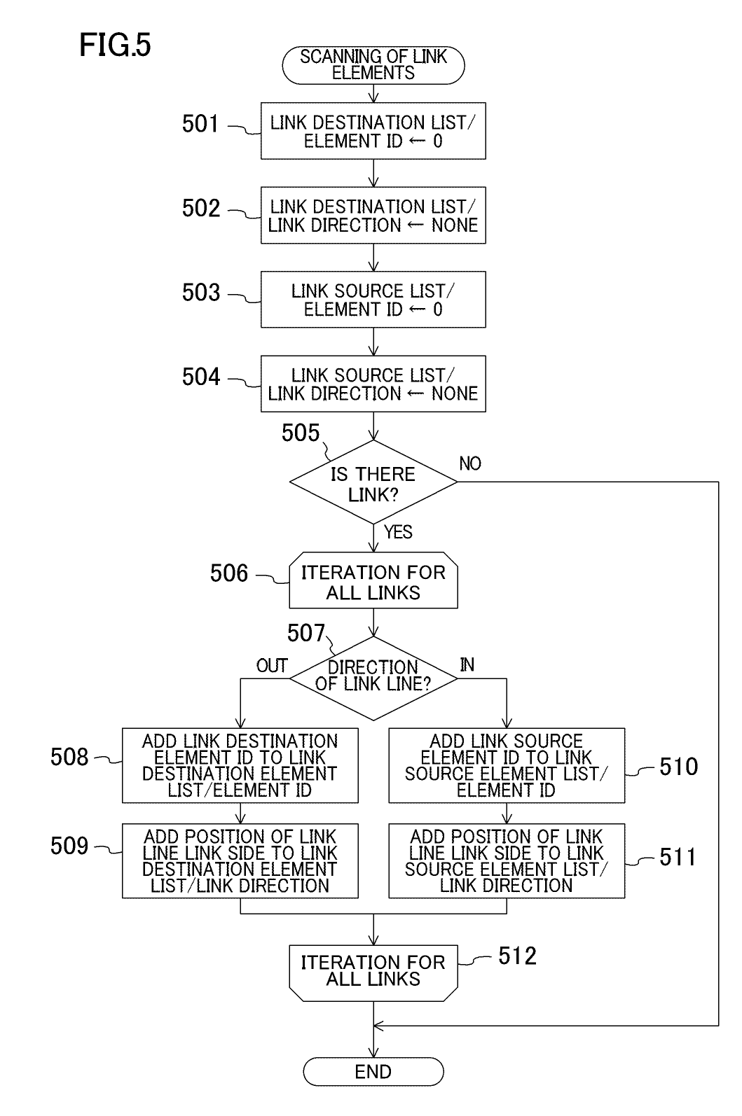

FIG. 5 shows a process flow of a link element scanning subroutine which is called in step 304 from the description element description content analysis subroutine of FIG. 3. Initially, element IDs in a link destination list are set to zero (501). Next, link directions in the link destination list are set to “none” (502). Next, element IDs in the link source list are set to zero (503). Next, link directions in the link source list are set to “none” (504). Next, it is determined whether or not there is a link to the currently processed description element (505). If there is no link, the process is ended. If there is a link or links, iteration is started for all the links (506). Next, it is determined in what direction a link line is linked (507). If the link line is linked in an outgoing direction, a link destination element ID is added to the element IDs in the link destination element list (508). Next, a position of a link line link side is added to the link directions in the link destination element list (509). If step 507 determines that the link line is linked in an incoming direction, a link source element ID is added to the element IDs in the link source element list (510). Next, a position of a link line link side is added to the link directions in the link source element list (511). Next, control returns to step 507 to begin a new iteration. Step 512 indicates an end point of the iterative process beginning at step 506.

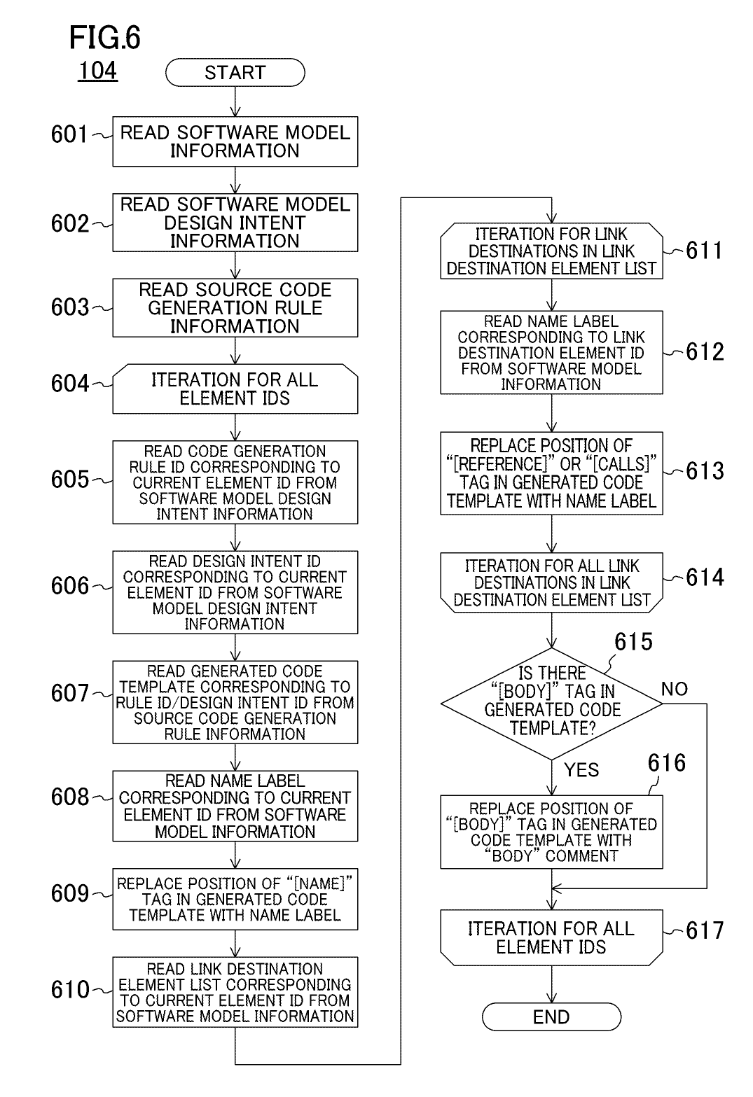

FIG. 6 shows a process flow of the source code generator 104. The source code generator 104 receives the initial software model information 121 or the generated software model information 122, the software model design intent information 123, and the source code generation rule information 125 which stores a rule for generating a source code, and outputs the initial generated source code 117 corresponding to the initial software model 115 or the regenerated source code 118 corresponding to the generated software model 116. Initially, the initial software model information 121 or the generated software model information 122 is read (601). Next, the software model design intent information 123 is read (602). Next, the source code generation rule information 125 is read (603). Next, iteration is started for all element IDs included in the initial software model information 121 or the generated software model information 122 (604). Next, a code generation rule ID corresponding to a current element ID is read from the software model design intent information 123 (605). Next, a design intent ID corresponding to the current element ID is read from the software model design intent information 123 (606). Next, a generated code template corresponding to the code generation rule ID and the design intent ID is read from the source code generation rule information 125 (607). Next, a name label corresponding to the current element ID is read from the initial software model information 121 or the generated software model information 122 (608). Next, a position of a “[name]” tag in the generated code template is replaced with the name label (609). Next, a link destination element list corresponding to the current element ID is read from the initial software model information 121 or the generated software model information 122 (610). Next, iteration is started for all link destinations in the link destination element list (611). Next, a name label corresponding to the link destination element ID is read from the initial software model information 121 or the generated software model information 122 (612). Next, a position of a “[reference]” or “[calls]” tag in the generated code template is replaced with the name label (613). Next, control returns to step 612 to begin a new iteration. Step 614 indicates an end point of the iterative process beginning at step 611. Next, it is determined whether or not there is a “[body]” tag in the generated code template (615). If there is a “[body]” tag, a position of the “[body]” tag in the generated code template is replaced with a “body” comment (616). Next, control returns to step 604 to begin a new iteration. Step 617 indicates an end point of the iterative process beginning at step 604.

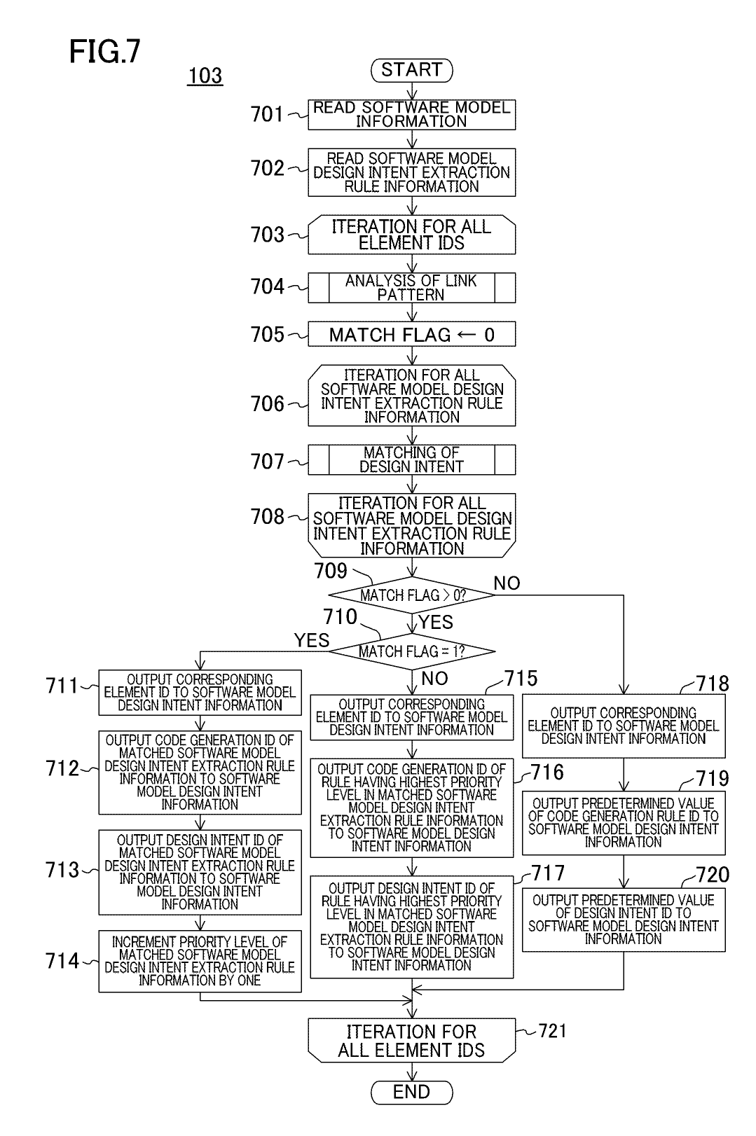

FIG. 7 shows a process flow of the software model design intent extractor 103. The software model design intent extractor 103 receives the initial software model information 121 or the generated software model information 122, and the software model design intent extraction rule information 124 which stores a rule for extracting a developer's design intent contained in a software model, and outputs the software model design intent information 123 which is data of design intent contained in a software model. Initially, the initial software model information 121 or the generated software model information 122 is read (701). Next, the software model design intent extraction rule information 124 is read (702). Next, iteration is started for all element IDs contained in the initial software model information 121 or the generated software model information 122 (703). Next, link pattern analysis is performed for a currently processed element ID (704). Next, a match flag which is a determination flag indicating whether or not there is a software model description matching design intent is set to zero (705). Next, iteration is started for all the software model design intent extraction rule information 124 (706). Next, design intent matching is performed to determine whether a description of a software model matches design intent (707). Next, control returns to step 707 to begin a new iteration. Step 708 indicates an end point of the iterative process beginning at step 706.

Next, it is determined whether or not the match flag is greater than zero (709). If the match flag is not greater than zero, a corresponding element ID is output to the software model design intent information 123 (718). Next, a predetermined value of the code generation rule ID is output to the software model design intent information 123 (719). Next, a predetermined value of the design intent ID is output to the software model design intent information 123 (720). If step 709 determines that the match flag is greater than zero, it is determined whether or not the match flag is equal to one (710). If the match flag is not equal to one, the current element ID is output to the software model design intent information 123 (715). Next, the code generation rule ID of a rule having a highest priority level in the matched software model design intent extraction rule information 124 is output to the software model design intent information 123 (716). Next, the design intent ID of the rule having a highest priority level in the matched software model design intent extraction rule information 124 is output to the software model design intent information 123 (717). If step 710 determines that the match flag is equal to one, the current element ID is output to the software model design intent information 123 (711). Next, the code generation rule ID in the matched software model design intent extraction rule information 124 is output to the software model design intent information 123 (712). Next, the design intent ID in the matched software model design intent extraction rule information 124 is output to the software model design intent information 123 (713). Next, the priority level of the matched software model design intent extraction rule information 124 is incremented by one (714). Next, control returns to step 704 to begin a new iteration. Step 721 indicates an end point of the iterative process beginning at step 703.

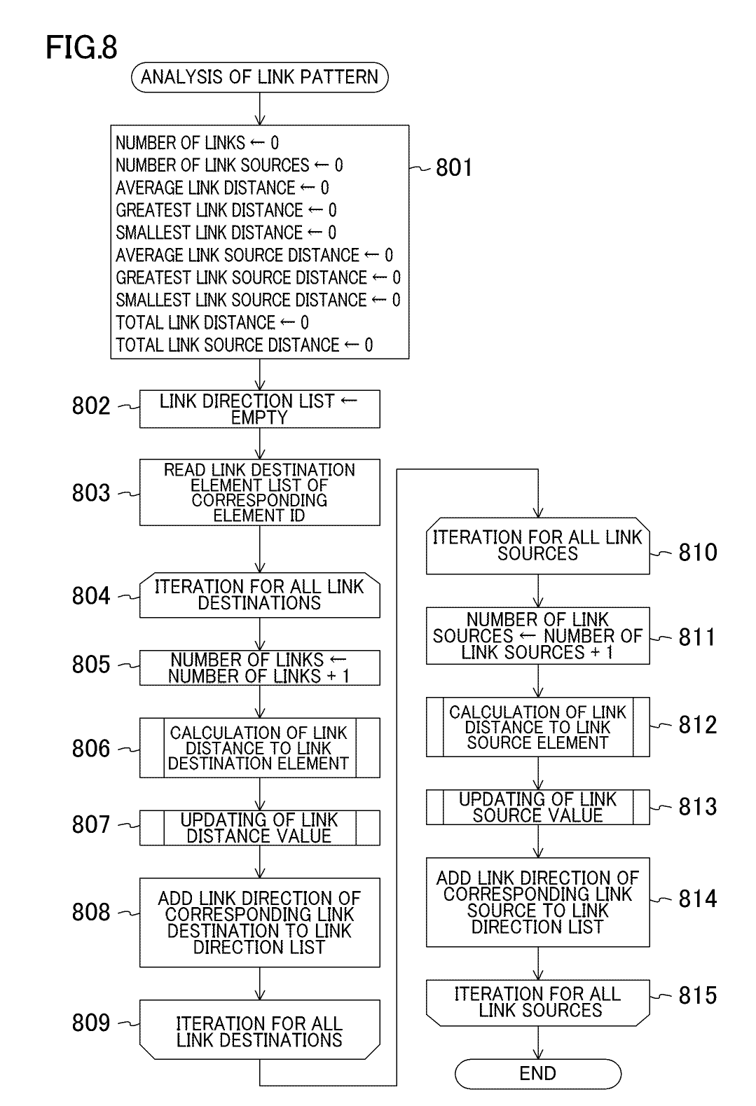

FIG. 8 shows a process flow of a link pattern analysis subroutine which is called in step 704 from the process flow of the software model design intent extractor 103 of FIG. 7. Initially, the number of links, the number of link sources, an average link distance, a greatest link distance, a smallest link distance, an average link source distance, a greatest link source distance, a smallest link source distance, a total link distance, and a total link source distance are each set to zero (801). Next, the link direction list is cleared (802). Next, the link destination element list of a corresponding element ID is read (803). Next, iteration is started for all link destinations (804). Next, the number of links is incremented by one (805). Next, a link distance to a link destination element is calculated (806). Next, the link distance value is updated (807). Next, the link direction of a corresponding link destination is added to the link direction list (808). Next, control returns to step 804 to begin a new iteration. Step 809 indicates an end point of the iterative process beginning at step 804. Next, an iterative process is started for all link sources (810). Next, the number of link sources is incremented by one (811). Next, a link distance to a link source element is calculated (812). Next, the link source distance value is updated (813). Next, the link direction of a corresponding link source is added to the link direction list (814). Next, control returns to step 811 to begin a new iteration. Step 815 indicates an end point of the iterative process beginning at step 810.

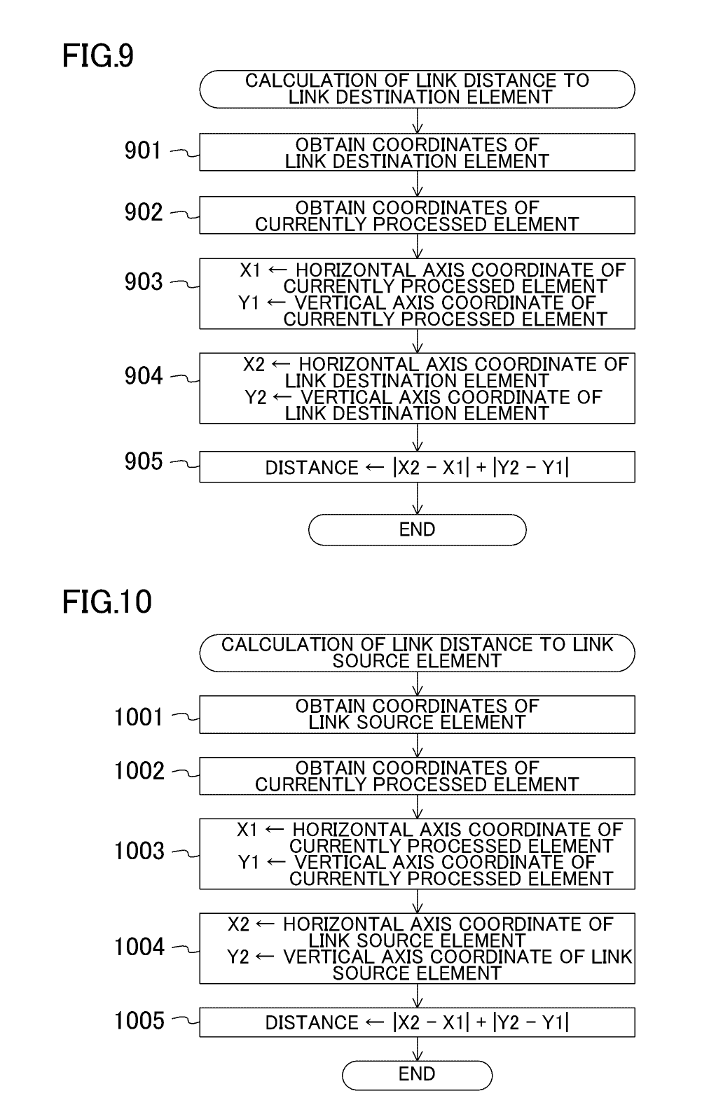

FIG. 9 shows a process flow of a subroutine of calculating a link distance to a link destination element, which is called in step 806 from the link pattern analysis subroutine of FIG. 8. Initially, coordinates of a link destination element are obtained (901). Next, coordinates of a currently processed element are obtained (902). Next, X1 is set to the horizontal axis coordinate of the currently processed element, and Y1 is set to the vertical axis coordinate of the currently processed element (903). Next, X2 is set to the horizontal axis coordinate of the link destination element, and Y2 is set to the vertical axis coordinate of the link destination element (904). Next, |X2−X1|+|Y2−Y1| is calculated as the distance (905).

FIG. 10 shows a process flow of a subroutine of calculating a link distance to a link source element, which is called in step 812 from the link pattern analysis subroutine of FIG. 8. Initially, coordinates of a link source element are obtained (1001). Next, coordinates of a currently processed element are obtained (1002). Next, X1 is set to the horizontal axis coordinate of the currently processed element, and Y1 is set to the vertical axis coordinate of the currently processed element (1003). Next, X2 is set to the horizontal axis coordinate of the link source element, and Y2 is set to the vertical axis coordinate of the link source element (1004). Next, |X2−X1|+|Y2−Y1| is calculated as the distance (1005).

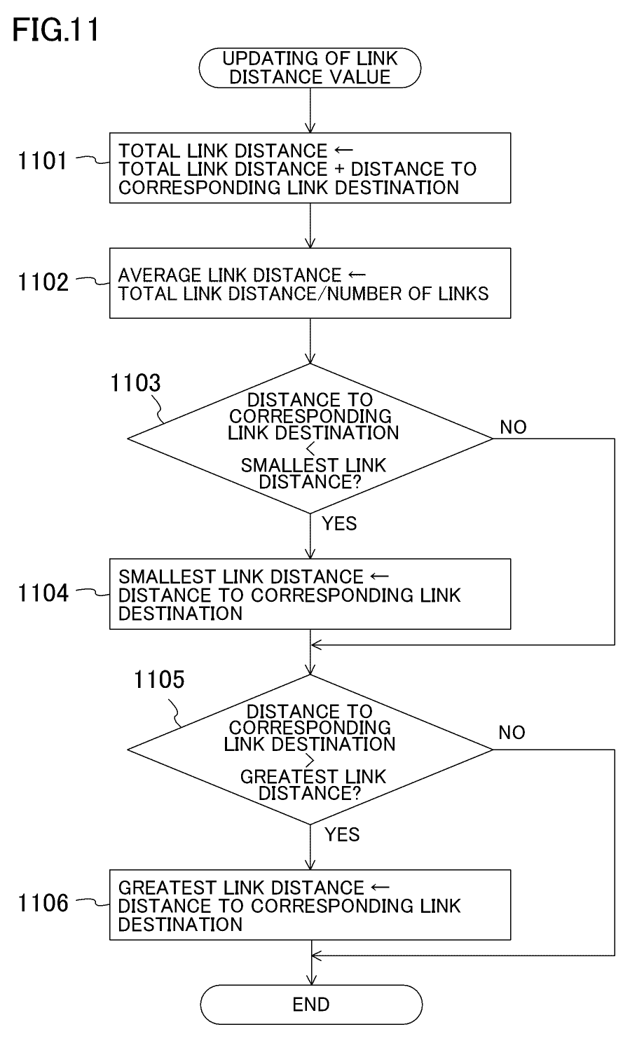

FIG. 11 shows a process flow of a link distance value updating subroutine which is called in step 807 from the link pattern analysis subroutine of FIG. 8. Initially, a distance to a corresponding link destination is added to the total link distance (1101). Next, the average link distance is set to a value obtained by dividing the total link distance by the number of links (1102). Next, it is determined whether or not the distance to the link destination is smaller than the smallest link distance (1103). If the distance to the link destination is not smaller than the smallest link distance, control proceeds to step 1105. If the distance to the link destination is smaller than the smallest link distance, the smallest link distance is set to the distance to the link destination (1104). Next, it is determined whether or not the distance to the link destination is greater than the greatest link distance (1105). If the distance to the link destination is not greater than the greatest link distance, the process is ended. If the distance to the link destination is greater than the greatest link distance, the greatest link distance is set to the distance to the link destination (1106).

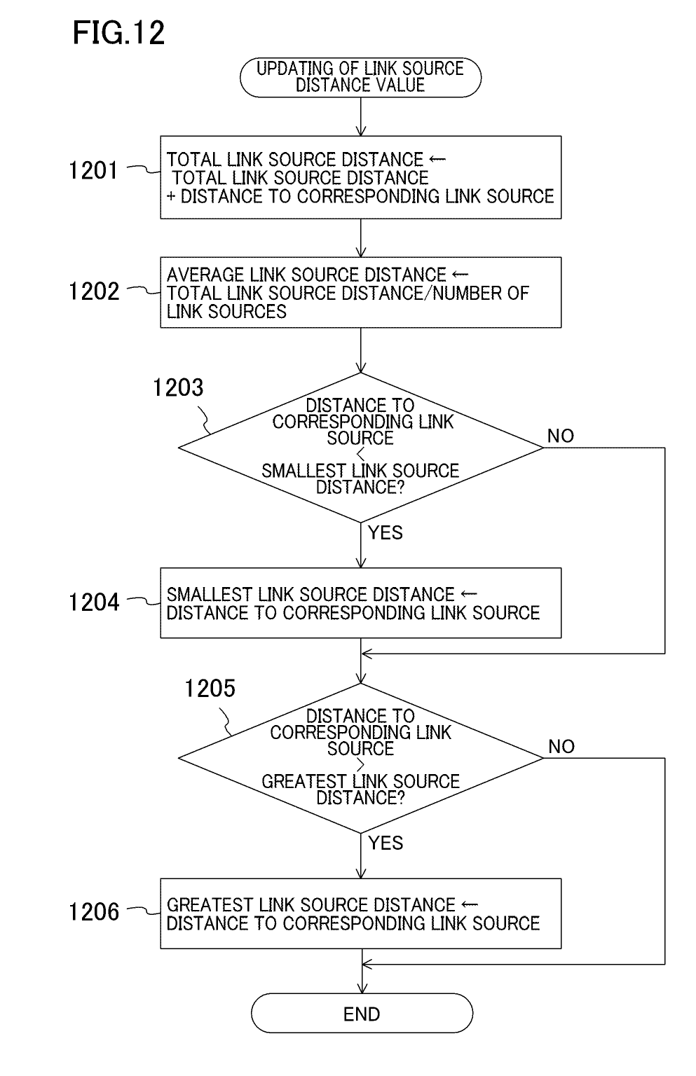

FIG. 12 shows a process flow of a link source distance value updating subroutine which is called in step 813 from the link pattern analysis subroutine of FIG. 8. Initially, a distance to a corresponding link source is added to the total link source distance (1201). Next, the average link source distance is set to a value obtained by dividing the total link source distance by the number of link sources (1202). Next, it is determined whether or not the distance to the link source is smaller than the smallest link source distance (1203). If the distance to the link source is not smaller than the smallest link source distance, control proceeds to step 1205. If the distance to the link source is smaller than the smallest link source distance, the smallest link source distance is set to the distance to the link source (1204). Next, it is determined whether or not the distance to the link source is greater than the greatest link source distance (1205). If the distance to the link source is not greater than the greatest link source distance, the process is ended. If the distance to the link source is greater than the greatest link source distance, the greatest link source distance is set to the distance to the link source (1206).

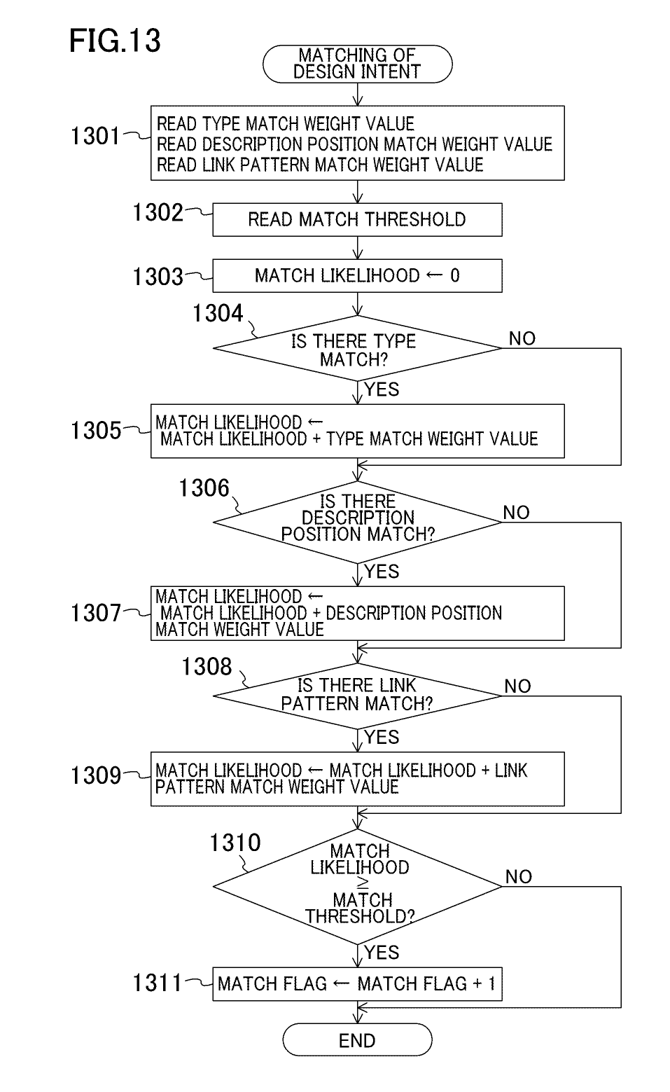

FIG. 13 is a process flow of a design intent matching subroutine which is called in step 707 from the software model design intent extractor 103 of FIG. 7. Initially, a type match weight value, a description position match weight value, and a link pattern match weight value are read (1301). Next, a match threshold is read (1302). Next, a match likelihood is set to zero (1303). Next, it is determined whether or not there is a type match (1304). When there is not a type match, control proceeds to step 1306. If there is a type match, the type match weight value is added to the match likelihood (1305). Next, it is determined whether or not there is a description position match (1306). If there is not a description position match, control proceeds to step 1308. If there is a description position match, the description position match weight value is added to the match likelihood (1307). Next, it is determined whether or not there is a link pattern match (1308). If there is not a link pattern match, control proceeds to step 1310. If there is a link pattern match, the link pattern match weight value is added to the match likelihood (1309). Next, it is determined whether or not the match likelihood is greater than or equal to the match threshold (1310). If the match likelihood is smaller than the match threshold, the process is ended. If the match likelihood is greater than or equal to the match threshold, the value of the match flag is incremented by one (1311).

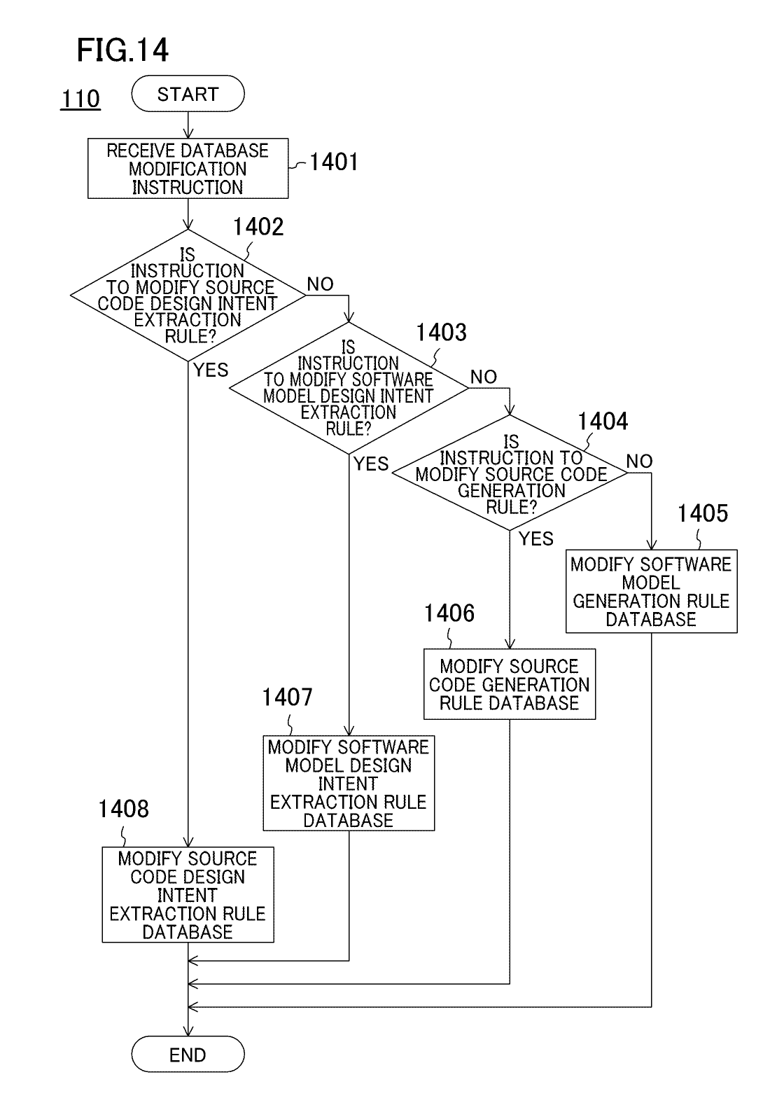

FIG. 14 shows a process flow of the database update manager 110. The database update manager 110 instructs the rule database section 105 to modify a database in response to an instruction from the rule modifier 111. Initially, an instruction to modify a database is received (1401). Next, it is determined whether or not the instruction is to modify a source code design intent extraction rule (1402). If the instruction is not to modify a source code design intent extraction rule, control proceeds to step 1403. If the instruction is to modify a source code design intent extraction rule, the source code design intent extraction rule database 108 is modified (1408). Next, it is determined whether or not the instruction is to modify a software model design intent extraction rule (1403). If the instruction is not to modify a software model design intent extraction rule, control proceeds to step 1404. If the instruction is to modify a software model design intent extraction rule, the software model design intent extraction rule database 107 is modified (1407). Next, it is determined whether or not the instruction is to modify a source code generation rule (1404). If the instruction is not to modify a source code generation rule, the software model generation rule database 106 is modified (1405). If the instruction is to modify a source code generation rule, the source code generation rule database 109 is modified (1406).

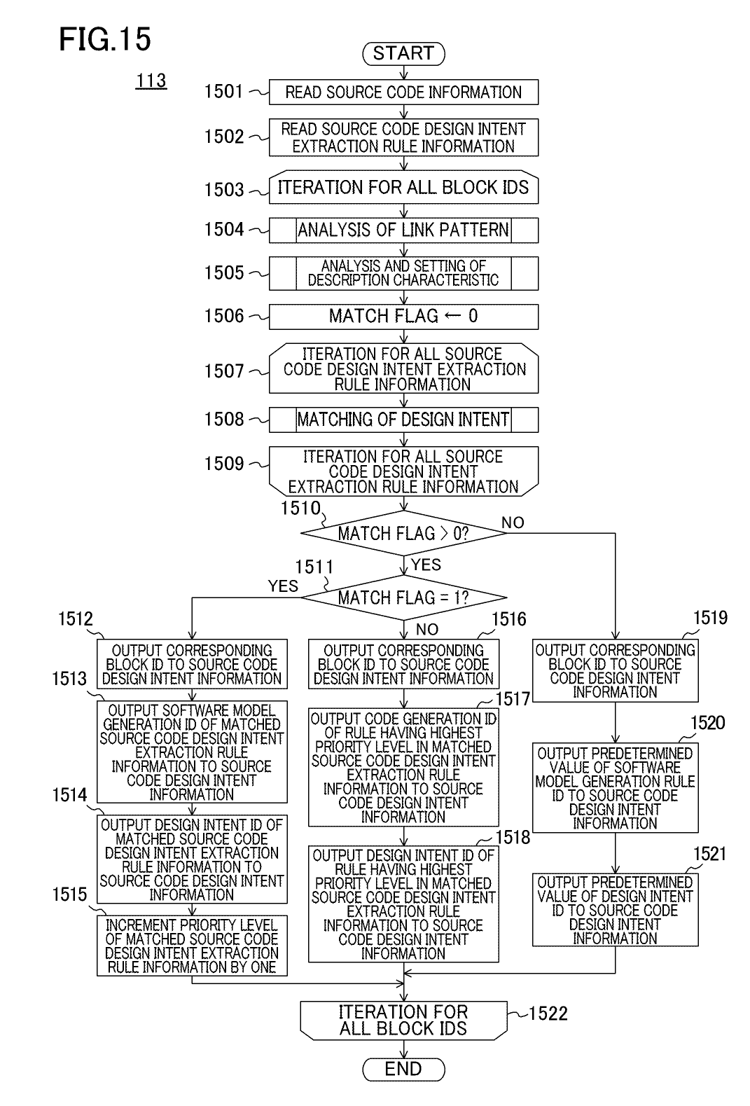

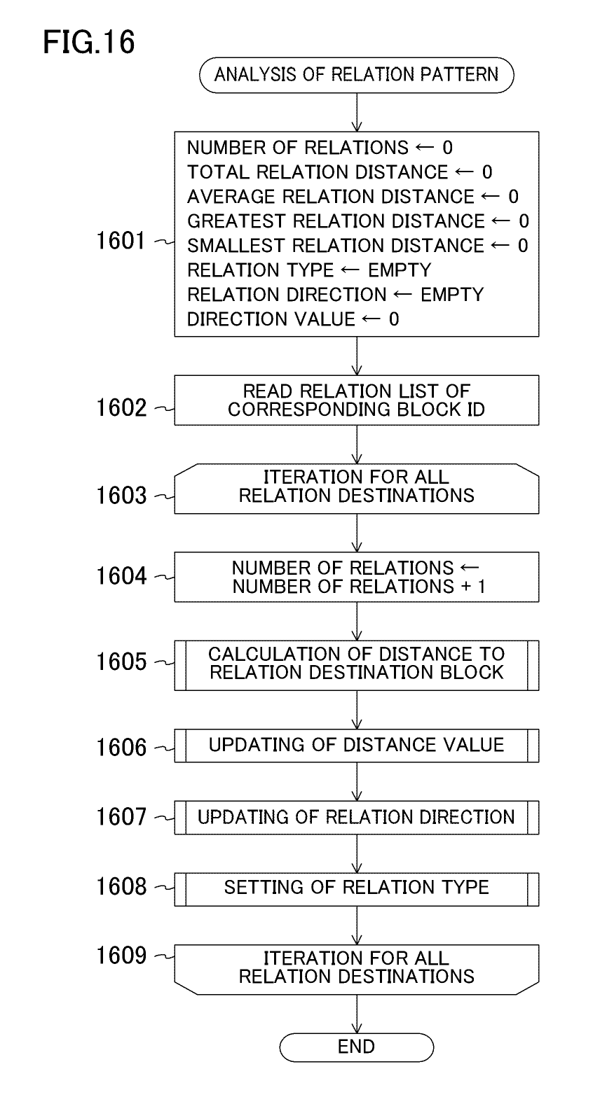

FIG. 15 shows a process flow of the source code design intent extractor 113. The source code design intent extractor 113 receives the modified source code information 129 or the regenerated source code information 128, and the source code design intent extraction rule information 126 which stores a rule for extracting a developer's design intent contained in a source code, and outputs the source code design intent information 130 which is data of design intent contained in a source code. Initially, the modified source code information 129 or the regenerated source code information 128 is read (1501). Next, the source code design intent extraction rule information 126 is read (1502). Next, an iterative process is started for all block IDs contained in the read source code information (1503). Next, a relation pattern indicating a link between blocks is analyzed (1504). Next, a description characteristic of a block is analyzed and set (1505). Next, a match flag indicating whether or not there is a design intent match is set to zero (1506). Next, an iterative process is started for all the source code design intent extraction rule information 126 (1507). Next, design intent matching is performed to determine whether or not the design intent matches a currently processed block (1508). Next, control returns to step 1508 to begin a new iteration. Step 1509 indicates an end point of the iterative process beginning at step 1507.

Next, it is determined whether or not the match flag is greater than zero (1510). If the match flag is not greater than zero, a corresponding block ID is output to the source code design intent information 130 (1519). Next, a predetermined value of the software model generation rule ID is output to the source code design intent information 130 (1520). Next, a predetermined value of the design intent ID is output to the source code design intent information 130 (1521). Next, control returns to step 1504 to begin a new iteration. Step 1522 indicates an end point of the iterative process beginning at step 1503. If step 1510 determines that the match flag is greater than zero, it is determined whether or not the match flag is equal to one (1511). If the match flag is not equal to one, the block ID is output to the source code design intent information 130 (1516). Next, the code generation rule ID of a rule having a highest priority level in the matched source code design intent extraction rule information 126 is output to the source code design intent information 130 (1517). Next, the design intent ID of a rule having a highest priority level in the matched the source code design intent extraction rule information 126 is output to the source code design intent information 130 (1518). Next, control returns to step 1504 to begin a new iteration. Step 1522 indicates an end point of the iterative process beginning at step 1503. If step 1511 determines that the match flag is equal to one, the block ID is output to the source code design intent information 130 (1512). Next, the software model generation rule ID in the matched source code design intent extraction rule information 126 is output to the source code design intent information 130 (1513). Next, the design intent ID in the matched source code design intent extraction rule information 126 is output to the source code design intent information 130 (1514). Next, the priority level of the matched source code design intent extraction rule information 126 is incremented by one (1515). Next, control returns to step 1504 to begin a new iteration. Step 1522 indicates an end point of the iterative process beginning at step 1503.

FIG. 16 shows a process flow of a relation pattern analysis subroutine which is called in step 1504 from the process flow of the source code design intent extractor 113 of FIG. 15. Initially, the number of relations, a total relation distance, an average relation distance, a greatest relation distance, a smallest relation distance, and a direction value are set to zero. Also, a relation type and a relation direction are cleared (1601). Next, a relation list of the corresponding block ID is read (1602). Next, an iterative process is started for all relation destinations contained in the relation list of the block ID (1603). Next, the number of relations is incremented by one (1604). Next, a distance to a relation destination block is calculated (1605). Next, the distance value is updated (1606). Next, the relation direction is updated (1607). Next, the relation type is set (1608). Next, control returns to step 1604 to begin a new iteration. Step 1609 indicates an end point of the iterative process beginning at step 1603.

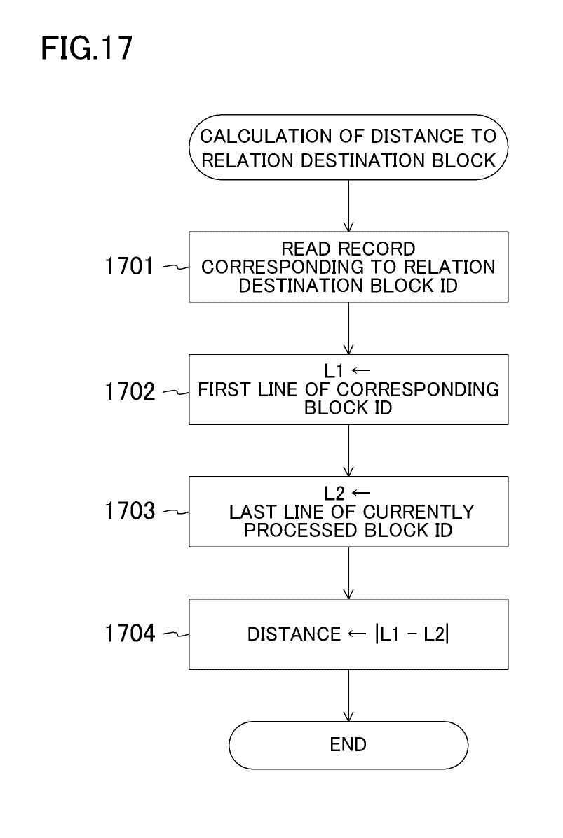

FIG. 17 shows a process flow of a subroutine of calculating a distance to a relation destination block, which is called in step 1605 from the relation pattern analysis subroutine of FIG. 16. Initially, records corresponding to a relation destination block ID are read (1701). Next, L1 is set to the first line of records of a corresponding block ID (1702). Next, L2 is set to the last line of records of a currently processed block ID (1703). Next, |L1−L2| is calculated as the distance (1704).

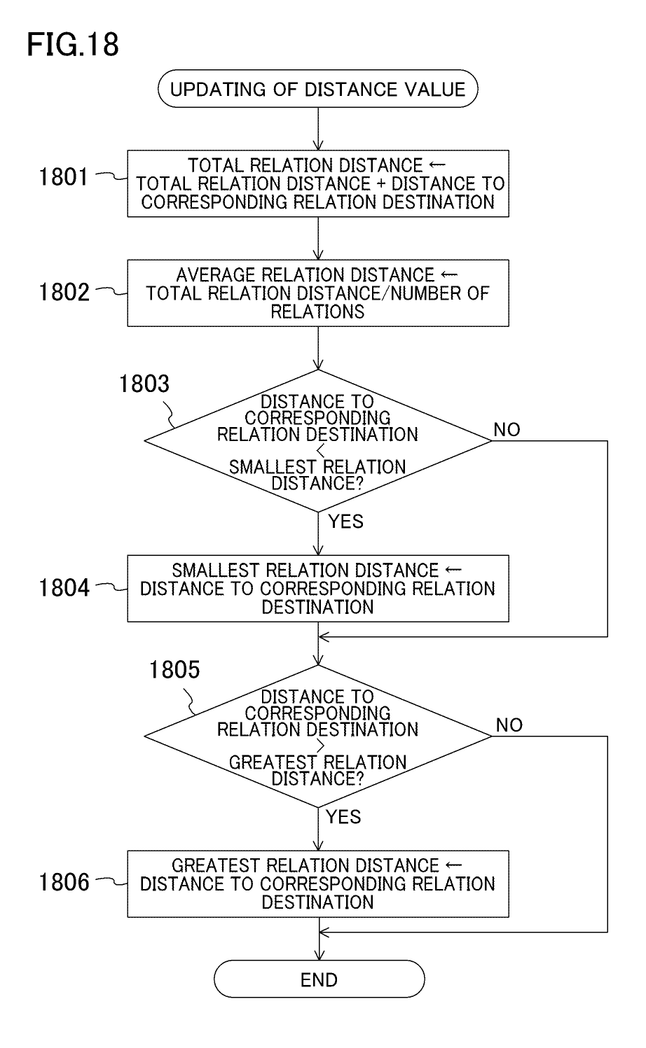

FIG. 18 is a process flow showing a distance value updating subroutine which is called in step 1606 from the relation pattern analysis subroutine of FIG. 16. Initially, a distance to a corresponding relation destination is added to the total relation distance (1801). Next, the average relation distance is set to a value obtained by dividing the total relation distance by the number of relations (1802). Next, it is determined whether or not the distance to the relation destination is smaller than the smallest relation distance (1803). If the distance to the relation destination is not smaller than the smallest relation distance, control proceeds to step 1805. If the distance to the relation destination is smaller than the smallest relation distance, the smallest relation distance is set to the distance to the relation destination (1804). Next, it is determined whether or not the distance to the relation destination is greater than the greatest relation distance (1805). If the distance to the relation destination is not greater than the greatest relation distance, the process is ended. If the distance to the relation destination is greater than the greatest relation distance, the greatest relation distance is set to the distance to the relation destination (1806).

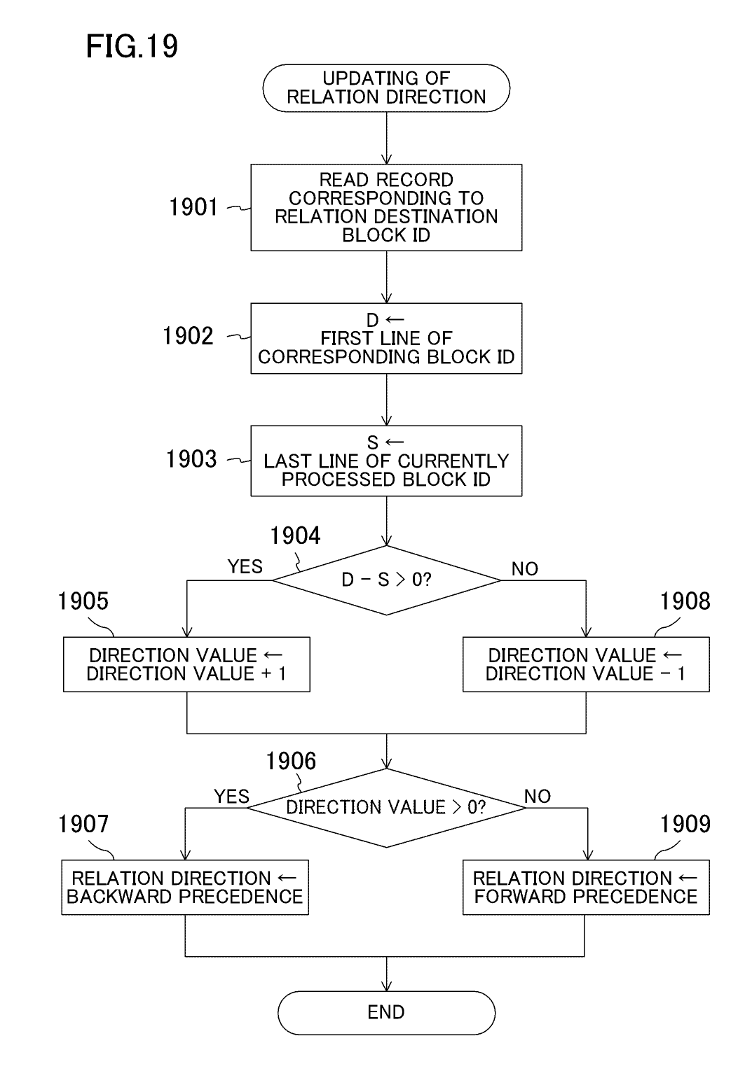

FIG. 19 shows a process flow of a relation direction updating subroutine which is called in step 1607 from the relation pattern analysis subroutine of FIG. 16. Initially, records corresponding to a relation destination block ID are read (1901). Next, D is set to the first line of a corresponding block ID (1902). Next, S is set to the first line of a currently processed block ID (1903). Next, it is determined whether or not D−S is greater than zero (1904). If D−S is greater than zero, the direction value is incremented by one (1905). If step 1904 determines that D−S is not greater than zero, the direction value is decremented by one (1908). Next, it is determined whether or not the direction value is greater than zero (1906). If the direction value is greater than zero, the relation direction is set to backward precedence (1907). If step 1906 determines that the direction value is not greater than zero, the relation direction is set to forward precedence (1909).

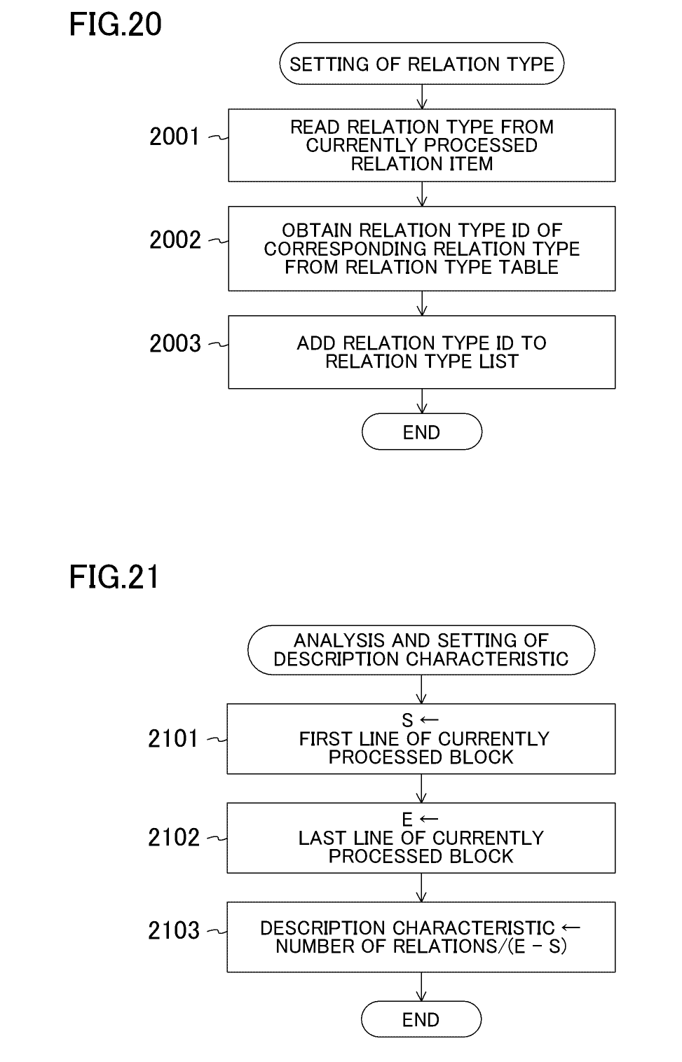

FIG. 20 shows a process flow of a relation type setting subroutine which is called in step 1608 from the relation pattern analysis subroutine of FIG. 16. Initially, a relation type is read from a currently processed related item (2001). Next, a relation type ID of the relation type is obtained from a relation type table (2002). Next, the relation type ID is added to a relation type list (2003).

FIG. 21 shows a process flow of a description characteristic analysis and setting subroutine which is called in step 1505 from the process flow of the source code design intent extractor 113 of FIG. 15. Initially, S is set to the first line of a currently processed block (2101). Next, E is set to the last line of the currently processed block (2102). Next, the description characteristic is set to the value of (the number of relations)/(E−S) (2103).

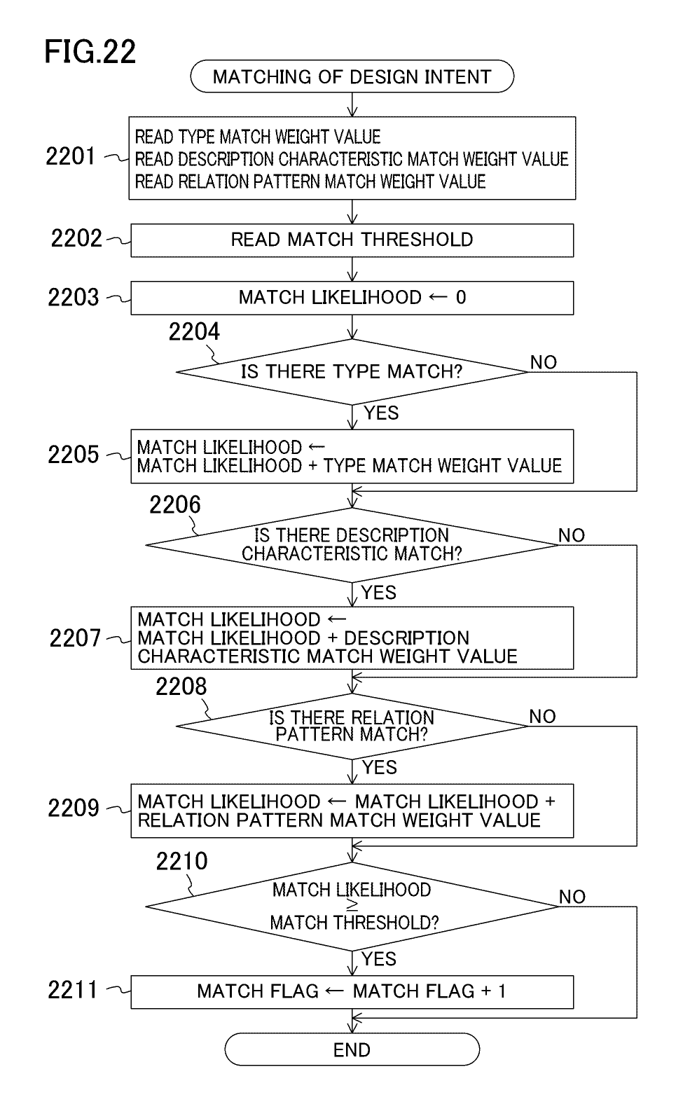

FIG. 22 shows a process flow of a design intent matching subroutine which is called in step 1508 from the process flow of the source code design intent extractor 113 of FIG. 15. Initially, a type match weight value, a description characteristic match weight value, and a relation pattern match weight value are read (2201). Next, a match threshold is read (2202). Next, a match likelihood is set to zero (2203). Next, it is determined whether or not there is a type match (2204). If there is not a type match, control proceeds to step 2206. If there is a type match, the type match weight value is added to the match likelihood (2205). Next, it is determined whether or not there is a description characteristic match (2206). If there is not a description characteristic match, control proceeds to step 2208. If there is a description characteristic match, the description characteristic match weight value is added to the match likelihood (2207). Next, it is determined whether or not there is a relation pattern match (2208). If there is not a relation pattern match, control proceeds to step 2210. If there is a relation pattern match, the relation pattern match weight value is added to the match likelihood (2209). Next, it is determined whether or not the match likelihood is greater than or equal to the match threshold (2210). If the match likelihood is smaller than the match threshold, the process is ended. If the match likelihood is greater than or equal to the match threshold, the value of the match flag is incremented by one (2211).

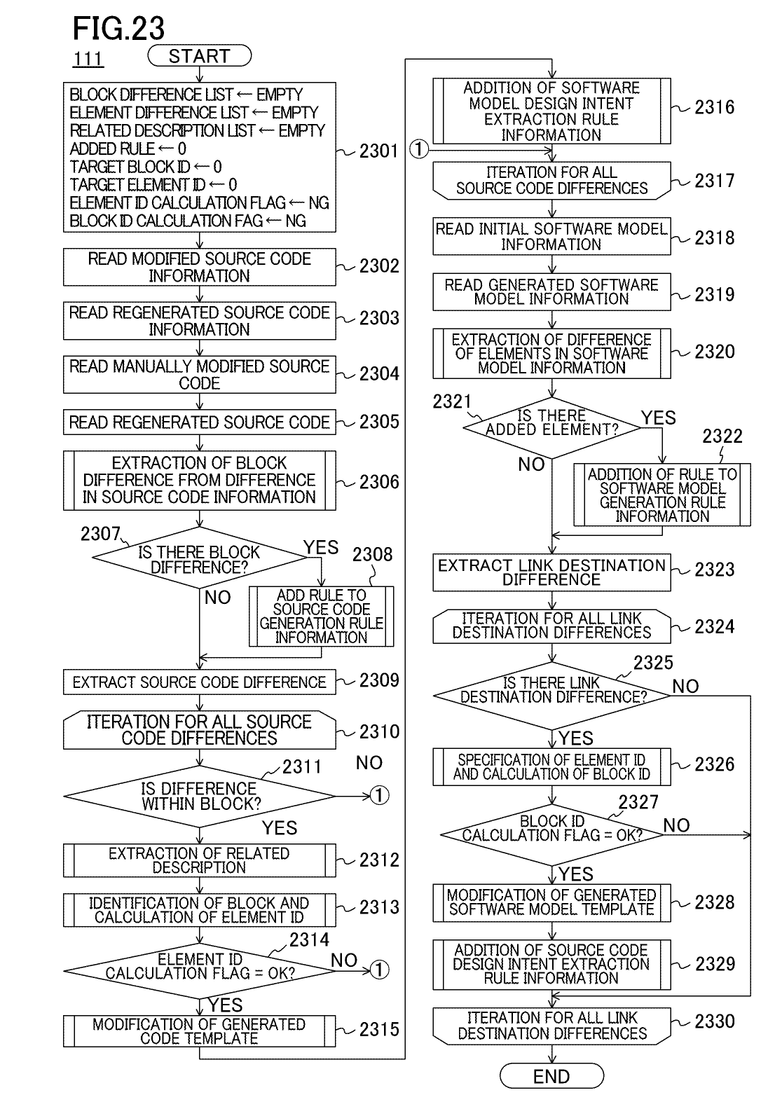

FIG. 23 shows a process flow of the rule modifier 111. The rule modifier 111 receives the initial software model information 121, the generated software model information 122, the software model design intent information 123, the software model design intent extraction rule information 124, the source code generation rule information 125, the modified source code information 129, the regenerated source code information 128, the software model generation rule information 127, the source code design intent extraction rule information 126, and the source code design intent information 130, and instructs the database update manager 110 to update a database. Initially, a block difference list, an element difference list, and a related description list are cleared. Also, an added rule ID, a target block ID, and a target element ID are set to zero. Also, an element ID calculation flag and a block ID calculation flag are set to NG (2301). Next, the modified source code information 129 is read (2302). Next, the regenerated source code information 128 is read (2303). Next, the manually modified source code 120 is read (2304). Next, the regenerated source code 118 is read (2305). Next, a block difference is extracted from a difference between each source code information (2306). Next, it is determined whether or not there is an extracted block difference (2307). If there is a block difference, a rule is added to the source code generation rule information 125 (2308). If step 2307 determines that there is not a block difference, a difference between each source code is extracted by a text process (2309). Next, an iterative process is started for all source code differences (2310). Next, it is determined whether or not the difference is a difference within a block (2311). If the difference is not a difference within a block, control returns to step 2310 to begin a new iteration. Step 2317 indicates an end point of the iterative process beginning at step 2310. If the difference is a difference within a block, a related description is extracted (2312). Next, a block to which the difference belongs is identified, and an element ID in which the block is described is calculated (2313). Next, it is determined whether or not the element ID calculation flag is OK (2314). If the element ID calculation flag is not OK, control returns to step 2310 to begin a new iteration. Step 2317 indicates an end point of the iterative process beginning at step 2310. If the element ID calculation flag is OK, the generated code template is modified (2315). Next, software model design intent extraction rule information is added (2316). Next, control returns to step 2310 to begin a new iteration. Step 2317 indicates an end point of the iterative process beginning at step 2310.

Next, the initial software model information 121 is read (2318). Next, the generated software model information 122 is read (2319). Next, a difference of elements contained in the software model information is extracted (2320). Next, it is determined whether or not there is an added element, based on the extracted difference (2321). If there is an added element, a rule is added to the software model generation rule information 127, and control proceeds to step 2323 (2322). If step 2321 determines that there is not an added element, a link destination difference is extracted (2323). Next, an iterative process is started for all link destination differences (2324). Next, it is determined whether or not there is a link destination difference (2325). If there is not a link destination difference, control returns to step 2324 to begin a new iteration. Step 2330 indicates an end point of the iterative process beginning at step 2324. If there is a link destination difference, an element ID is specified to calculate a block ID (2326). Next, it is determined whether or not the block ID calculation flag is OK (2327). If the block ID calculation flag is not OK, control returns to step 2324 to begin a new iteration. Step 2330 indicates an end point of the iterative process beginning at step 2324. If step 2327 determines that the block ID calculation flag is OK, a generated software model template is modified (2328). Next, source code design intent extraction rule information is added (2329). Next, control returns to step 2324 to begin a new iteration. Step 2330 indicates an end point of the iterative process beginning at step 2324.

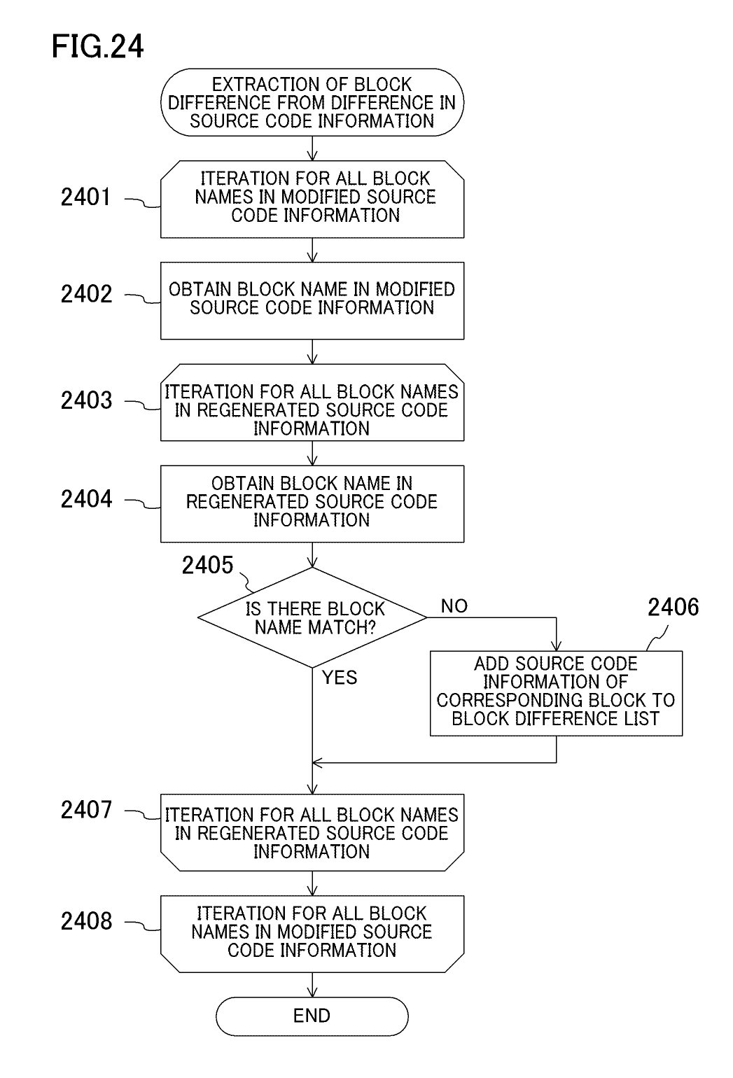

FIG. 24 shows a process flow of a subroutine of extracting a block difference from a difference in source code information, which is called in step 2306 from the process flow of the rule modifier 111 of FIG. 23. Initially, an iterative process is started for all block names contained in the modified source code information 129 (2401). Next, a block name in the modified source code information is obtained (2402). Next, an iterative process is started for all block names contained in the regenerated source code information 128 (2403). Next, a block name in the regenerated source code information 128 is obtained (2404). Next, it is determined whether or not the block names match (2405). If the block names do not match, the source code information of a corresponding block is added to the block difference list (2406). Next, control returns to step 2403 to begin a new iteration. Step 2407 indicates an end point of the iterative process beginning at step 2403. If step 2405 determines that the block names match, control returns to step 2403 to begin a new iteration without performing step 2406. Step 2407 indicates an end point of the iterative process beginning at step 2403. Next, control returns to step 2401 to begin a new iteration. Step 2408 indicates an end point of the iterative process beginning at step 2401.

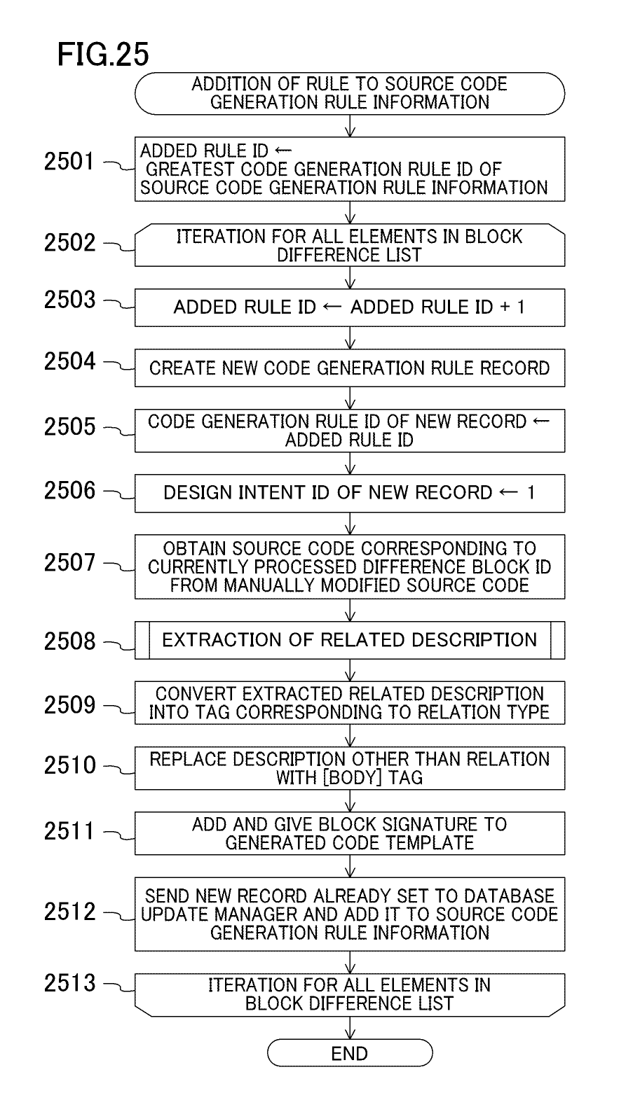

FIG. 25 shows a process flow of a subroutine of adding a rule to source code generation rule information, which is called in step 2308 from the process flow of the rule modifier 111 of FIG. 23. Initially, the added rule ID is set to a greatest code generation rule ID of the source code generation rule information (2501). Next, an iterative process is started for all elements in the block difference list (2502). Next, the added rule ID is incremented by one (2503). Next, a new code generation rule record is created (2504). Next, the code generation rule ID of the new record is set to the added rule ID (2505). Next, the design intent ID of the new record is set to one (2506). Next, a source code corresponding to a currently processed differential block ID is obtained from the manually modified source code 120 (2507). Next, a related description is extracted (2508). Next, the extracted related description is converted into a tag corresponding to the relation type (2509). Next, a description other than relation is replaced with the [body] tag (2510). Next, a block signature is added and given to the generated code template (2511). Next, the new record already set is sent to the database update manager 110 to be added to the source code generation rule information (2512). Next, control returns to step 2502 to begin a new iteration. Step 2513 indicates an end point of the iterative process beginning at step 2502.

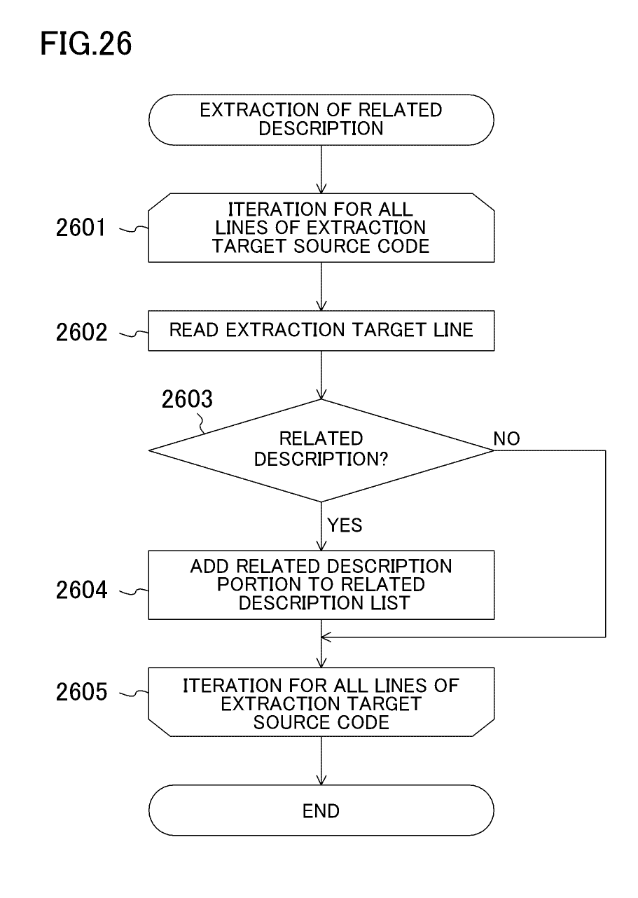

FIG. 26 shows a process flow of a subroutine of extracting a related description, which is called in step 2312 from the process flow of the rule modifier 111 of FIG. 23. Initially, an iterative process is started for all lines of an extraction target source code (2601). Next, an extraction target line is read (2602). Next, it is determined whether or not the read target line is a related description (2603). If the read target line is not a related description, control returns to step 2601 to begin a new iteration. Step 2605 indicates an end point of the iterative process beginning at step 2601. If step 2603 determines that the read target line is a related description, a related description portion is added to the related description list (2604). Next, control returns to step 2601 to begin a new iteration. Step 2605 indicates an end point of the iterative process beginning at step 2601. Note that the related description extraction subroutine of FIG. 26 is also called in step 2508 of FIG. 25.

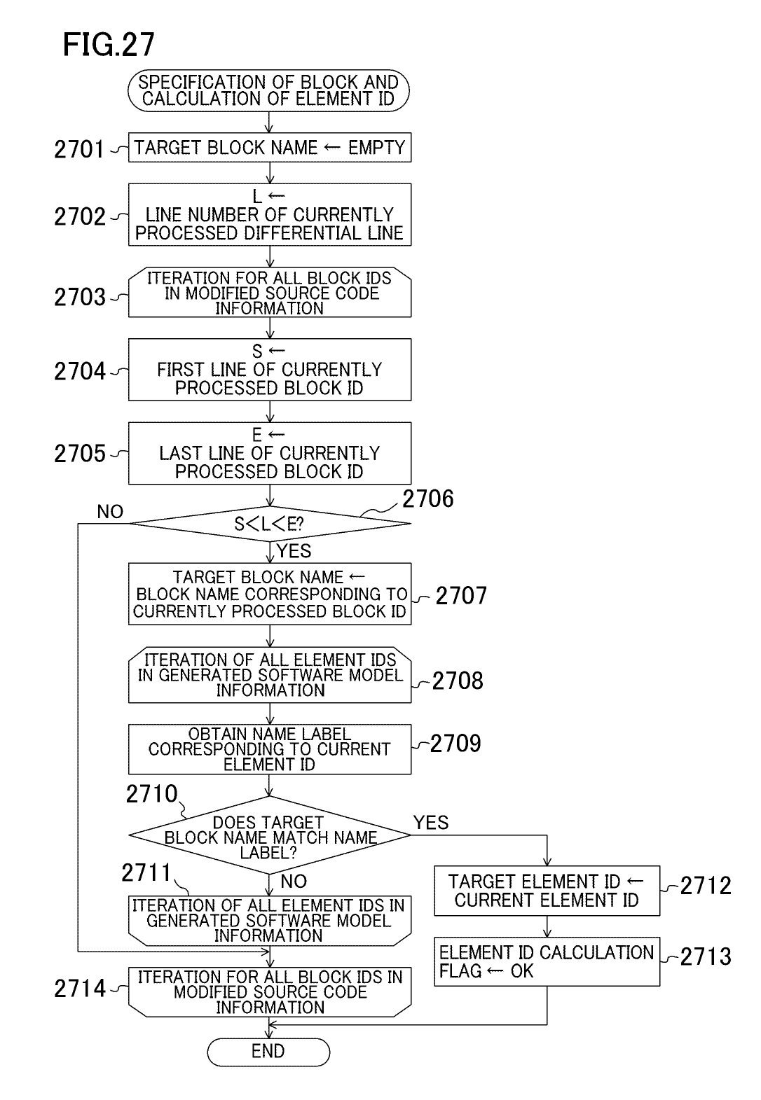

FIG. 27 shows a process flow of a subroutine of specifying a block and calculating an element ID, which is called in step 2313 from the process flow of the rule modifier 111 of FIG. 23. Initially, a target block name is cleared (2701). Next, L is set to the line number of a currently processed differential line (2702). Next, an iterative process is started for all blocks ID in the modified source code information 129 (2703). Next, S is set to the first line of a currently processed block ID (2704). Next, E is set to the last line of the currently processed block ID (2705). Next, it is determined whether or not S<L<E is satisfied (2706). If step 2706 determines that S<L<E is not satisfied, control returns to step 2703 to begin a new iteration. Step 2714 indicates an end point of the iterative process beginning at step 2703. If step 2706 determines that S<L<E is satisfied, the target block name is set to a block name corresponding to the currently processed block ID (2707). Next, an iterative process is started for all element IDs in the generated software model information 122 (2708). Next, a name label corresponding to a current element ID is obtained (2709). Next, it is determined whether or not the target block name matches the name label (2710). If the target block name does not match the name label, control returns to step 2708 to begin a new iteration. Step 2711 indicates an end point of the iterative process beginning at step 2708. If step 2710 determines that the target block name matches the name label, the target element ID is set to the current element ID (2712). Next, the element ID calculation flag is set to OK, and the process is ended (2713).

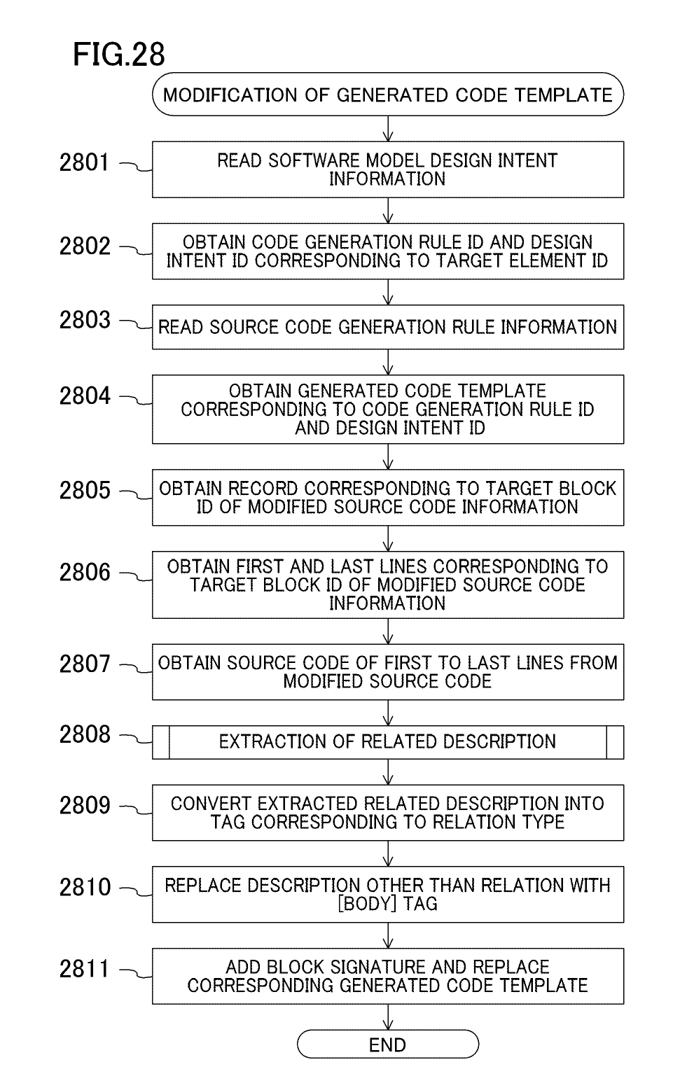

FIG. 28 shows a process flow of a generated code template modification subroutine which is called in step 2315 from the process flow of the rule modifier 111 of FIG. 23. Initially, the software model design intent information 123 is read (2801). Next, a code generation rule ID and a design intent ID which correspond to the target element ID are obtained (2802). Next, the source code generation rule information 125 is read (2803). Next, a generated code template corresponding to the code generation rule ID and the design intent ID is obtained (2804). Next, a record corresponding to a target block ID in the modified source code information 129 is obtained (2805). Next, the first and last lines corresponding to the target block ID in the modified source code information 129 are obtained (2806). Next, a source code from the first line to the last line is obtained from the modified source code (2807). Next, a related description is extracted (2808). Next, the extracted related description is converted into a tag corresponding to the type of the relation (2809). Next, a description other than the relation is replaced with the [body] tag (2810). Next, a block signature is added, and the corresponding generated code template is replaced (2811). Note that the related description extraction subroutine of FIG. 26 is also called in step 2808 of FIG. 28.

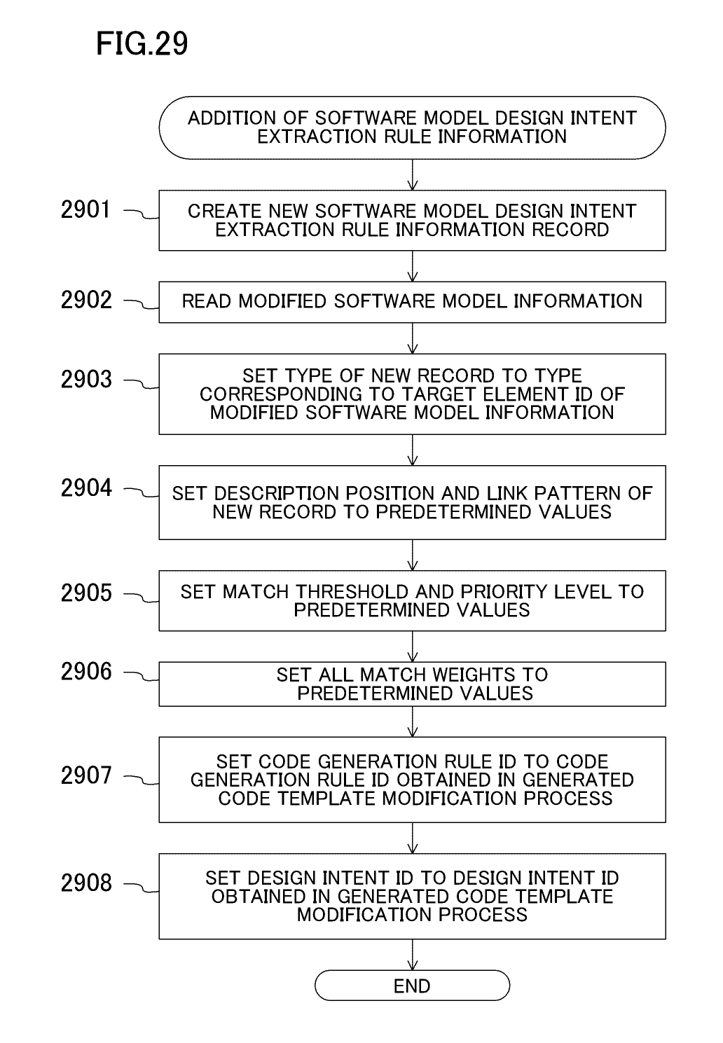

FIG. 29 shows a process flow of a software model design intent extraction rule information addition subroutine which is called in step 2316 from the process flow of the rule modifier 111 of FIG. 23. Initially, a new software model design intent extraction rule information record is created (2901). Next, modified software model information is read (2902). Next, the type of a new record is set to a type corresponding to a target element ID in the modified software model information (2903). Next, the description position and link pattern of the new record are set to predetermined values (2904). Next, the match threshold and the priority level are set to predetermined values (2905). Next, all the match weights are set to predetermined values (2906). Next, the code generation rule ID is set to a code generation rule ID obtained in the generated code template modification process (2907). Next, the design intent ID is set to a design intent ID obtained in the generated code template modification process (2908).

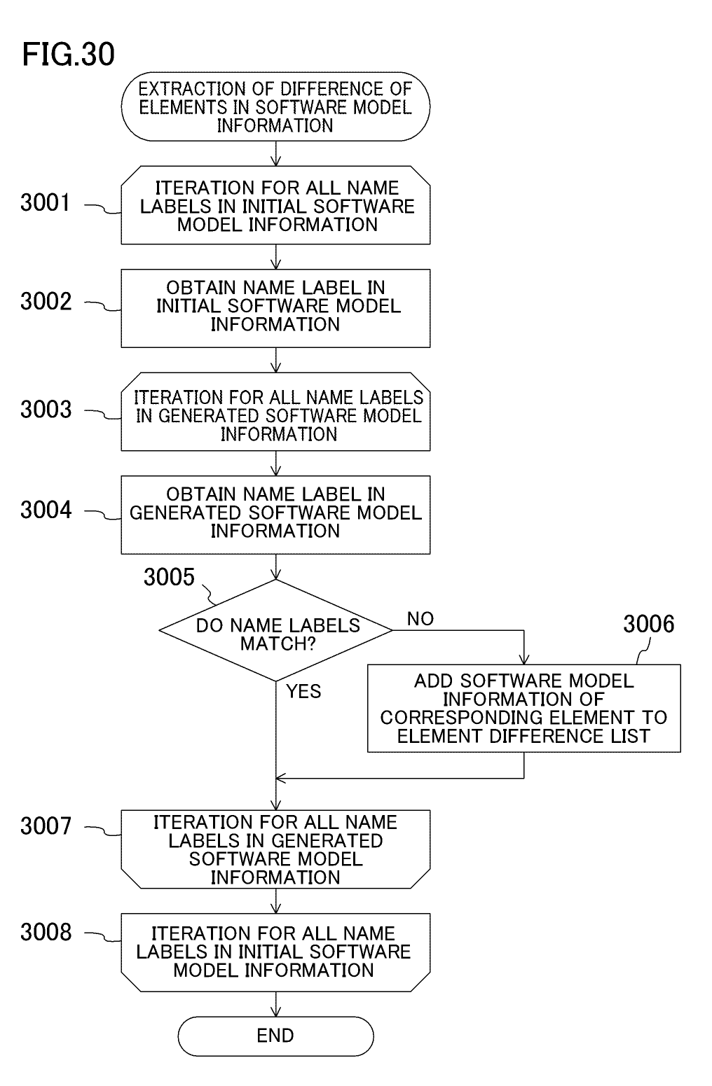

FIG. 30 shows a process flow of a subroutine of extracting an element difference of software model information, which is called in step 2320 from the process flow of the rule modifier 111 of FIG. 23. Initially, an iterative process is started for all name labels in the initial software model information 121 (3001). Next, a name label in the initial software model information 121 is obtained (3002). Next, an iterative process is started for all name labels in the generated software model information 122 (3003). Next, a name label in the generated software model information 122 is obtained (3004). Next, it is determined whether or not the name labels match (3005). If the name label do not match, the software model information of a corresponding element is added to the element difference list (3006). Next, control returns to step 3003 to begin a new iteration. Step 3007 indicates an end point of the iterative process beginning at step 3003. If step 3005 determines that the name labels match, control returns to step 3003 to begin a new iteration without performing step 3006. Step 3007 indicates an end point of the iterative process beginning at step 3003. Step 3008 indicates an end point of the iterative process beginning at step 3001.

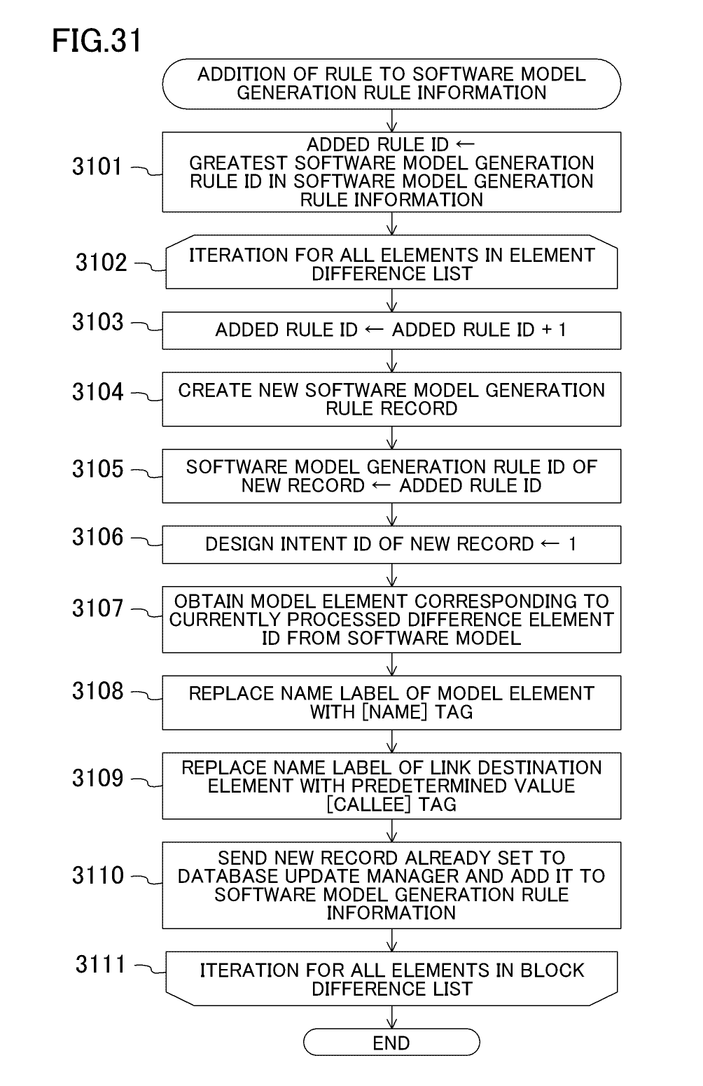

FIG. 31 shows a process flow of a subroutine of adding a rule to software model generation rule information, which is called in step 2322 from the process flow of the rule modifier 111 of FIG. 23. Initially, the added rule ID is set to a greatest software model generation rule ID in the software model generation rule information 127 (3101). Next, an iterative process is started for all elements in the element difference list (3102). Next, the added rule ID is incremented by one (3103). Next, a new software model generation rule record is created (3104). Next, the software model generation rule ID of the new record is set to the added rule ID (3105). Next, the design intent ID of the new record is set to one (3106). Next, a model element corresponding to a currently processed differential element ID is obtained from the software model (3107). Next, the name label of the model element is replaced with the [name] tag (3108). Next, the name label of a link destination element is replaced with a predetermined value, i.e., a [callee] tag (3109). Next, the new record already set is sent to the database update manager 110 and is added to the software model generation rule information (3110). Step 3111 indicates an end point of the iterative process beginning at step 3102.

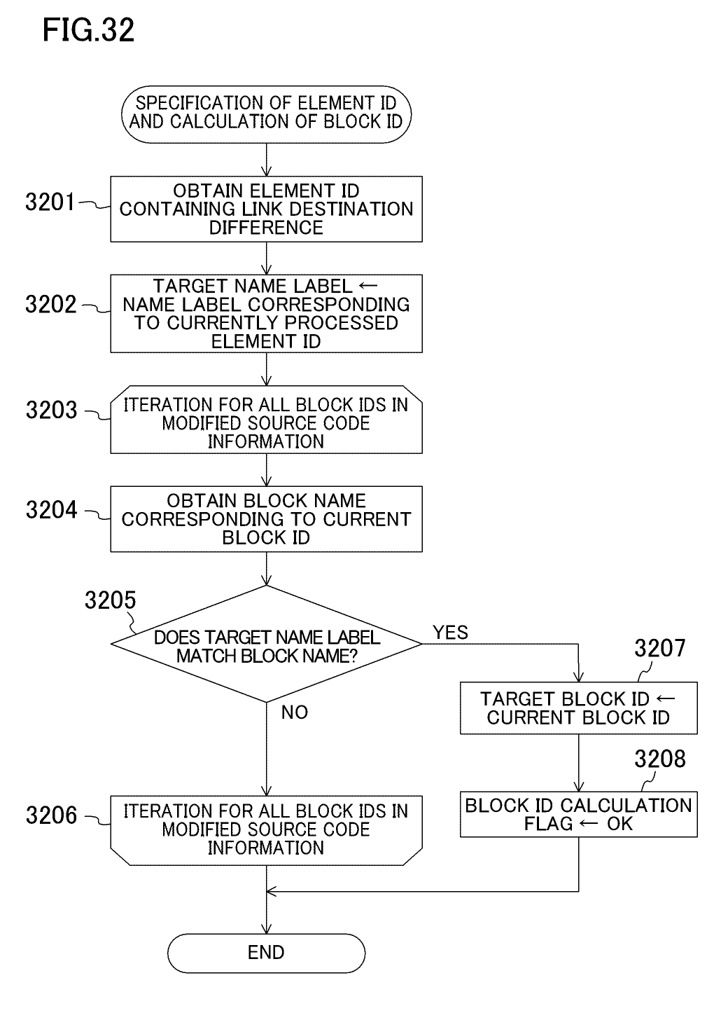

FIG. 32 shows a process flow of a subroutine of specifying an element ID and calculating a block ID, which is called in step 2326 from the process flow of the rule modifier 111 of FIG. 23. Initially, an element ID containing a link destination difference is obtained (3201). Next, a target name label is set to a name label corresponding to a currently processed element ID (3202). Next, an iterative process is started for all block IDs in the modified source code information 129 (3203). Next, a block name corresponding to a current block ID is obtained (3204). Next, it is determined whether or not the target name label matches the block name (3205). If the target name label does not match the block name, control returns to step 3203 to begin a new iteration. Step 3206 indicates an end point of the iterative process beginning at step 3203. If step 3205 determines that the target name label matches the block name, the target block ID is set to the current block ID (3207). Next, the block ID calculation flag is set to OK (3208).

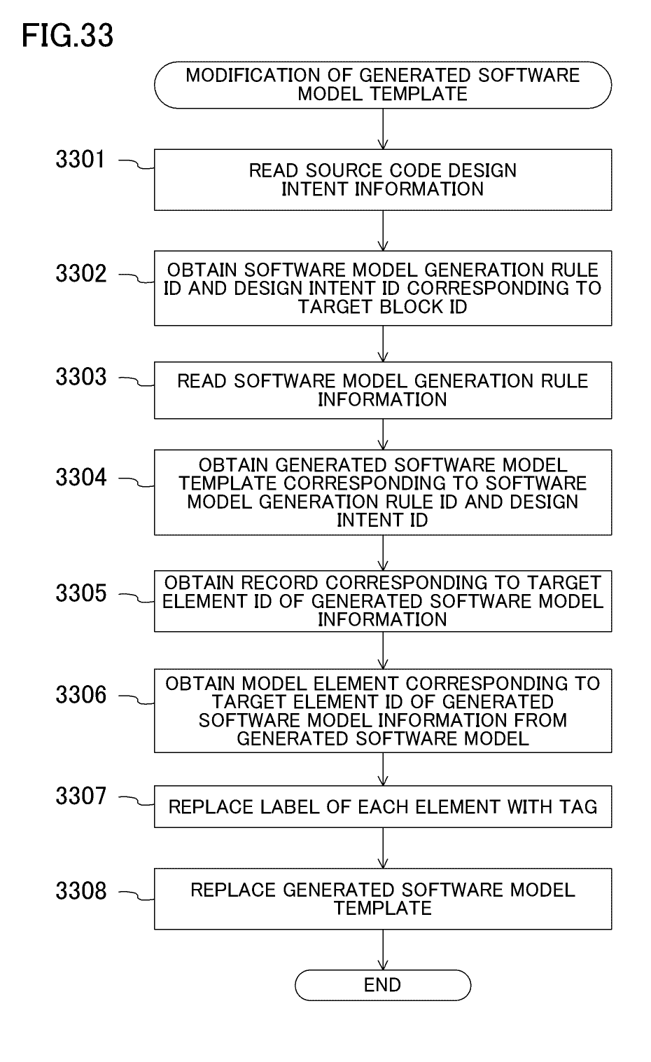

FIG. 33 shows a process flow of a generated software model template modification subroutine which is called in step 2328 from the process flow of the rule modifier 111 of FIG. 23. Initially, the source code design intent information 130 is read (3301). Next, a software model generation rule ID and a design intent ID which correspond to a target block ID are obtained (3302). Next, the software model generation rule information 127 is read (3303). Next, a generated software model template corresponding to the software model generation rule ID and the design intent ID is obtained (3304). Next, a record corresponding to a target element ID in the generated software model information 122 is obtained (3305). Next, a model element corresponding to the target element ID in the generated software model information 122 is obtained from the generated software model (3306). Next, the label of each element is replaced with a tag (3307). Next, the generated software model template is replaced (3308).

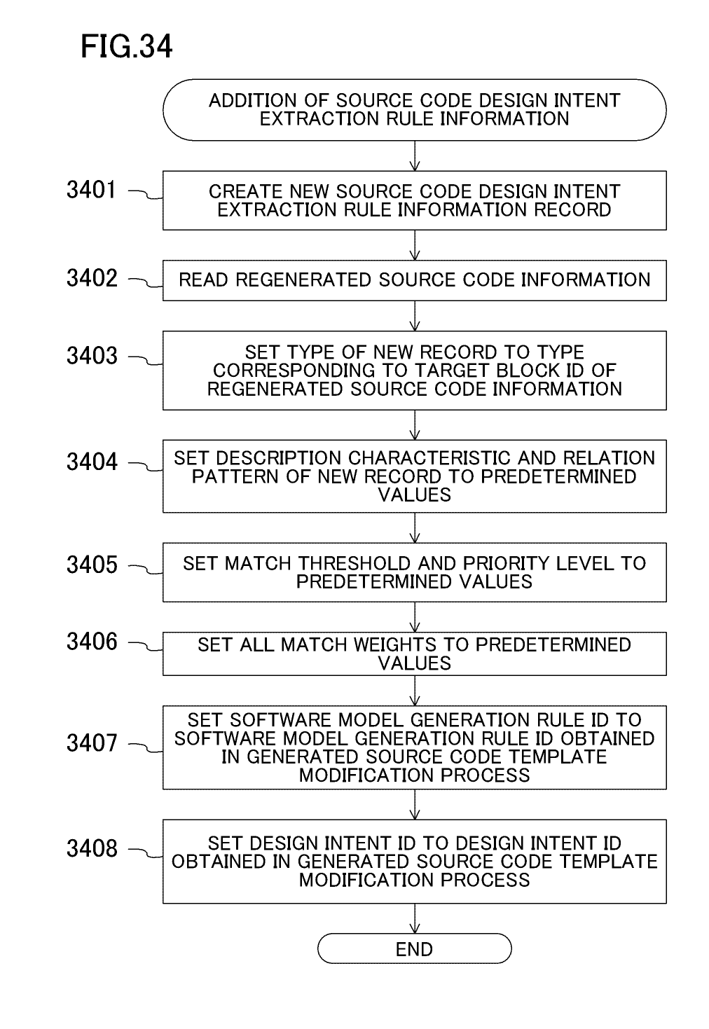

FIG. 34 shows a process flow of a source code design intent extraction rule information addition subroutine which is called in step 2329 from the process flow of the rule modifier 111 of FIG. 23. Initially, a new source code design intent extraction rule information record is created (3401). Next, the regenerated source code information 128 is read (3402). Next, the type of the new record is set to a type corresponding to a target block ID in the regenerated source code information 128 (3403). Next, the description characteristic and relation pattern of the new record are set to predetermined values (3404). Next, the match threshold and the priority level are set to predetermined values (3405). Next, all the match weights are set to predetermined values (3406). Next, the software model generation rule ID is set to a software model generation rule ID obtained in the generated source code template modification process (3407). Next, the design intent ID is set to a design intent ID obtained in the generated source code template modification process (3408).

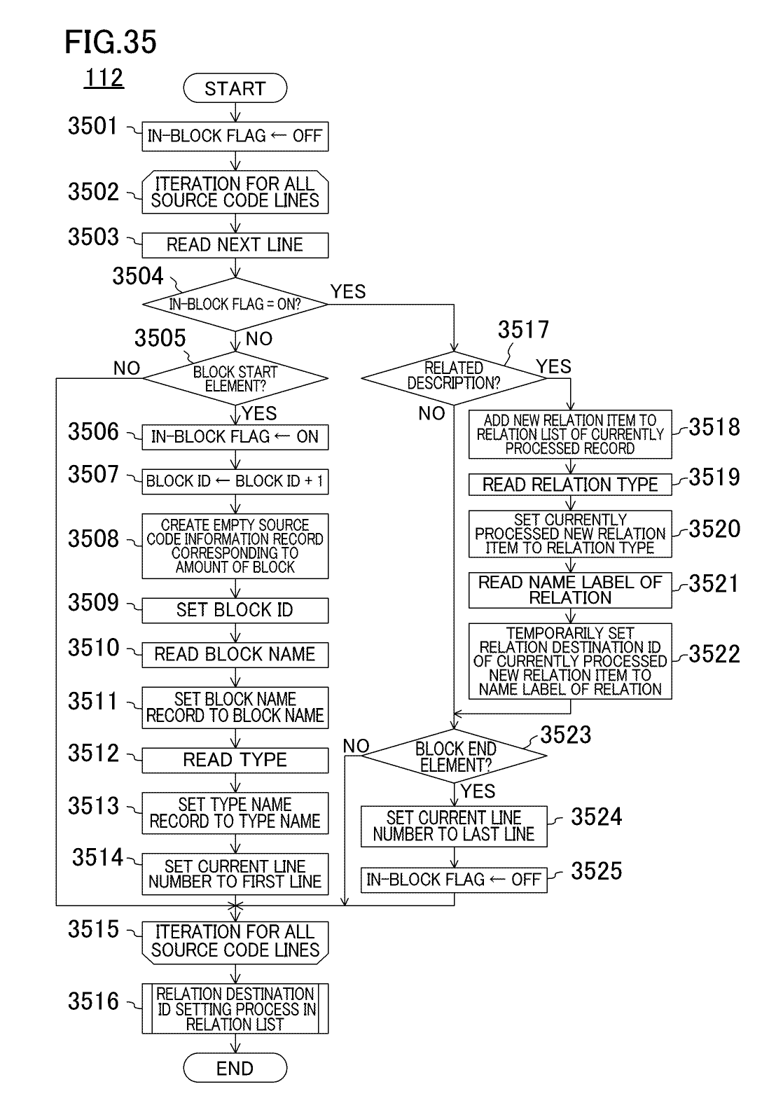

FIG. 35 shows a process flow of the source code reader 112. The source code reader 112 receives the manually modified source code 120 created or modified by the developer 119, converts the manually modified source code 120 into data which can be easily processed by a computer, and outputs the data as the regenerated source code information 128 or the modified source code information 129. Initially, an in-block flag is set to OFF (3501). Next, an iterative process is started for all source code lines (3502). Next, the next line is read (3503). Next, it is determined whether or not the in-block flag is ON (3504). If the in-block flag is not ON, it is determined whether the element is a block start element (3505). If the element is not a block start element, control returns to step 3502 to begin a new iteration. Step 3515 indicates an end point of the iterative process beginning at step 3502. If step 3505 determines that the element is a block start element, the in-block flag is set to ON (3506). Next, the block ID is incremented by one (3507). Next, an empty source code information record corresponding to the amount of a block is created (3508). Next, the block ID is given to the created source code information record (3509). Next, the block name is read (3510). Next, the block name record is set to the block name (3511). Next, the type is read (3512). Next, the type name record is set to the type name (3513). The first line is set to a current line number (3514). Next, control returns to step 3502 to begin a new iteration. Step 3515 indicates an end point of the iterative process beginning at step 3502. If step 3504 determines that the in-block flag is ON, it is determined whether or not the description is a related description (3517). If the description is not a related description, it is determined whether or not the element is a block end element (3523). If the element is not a block end element, control returns to step 3502 to begin a new iteration. Step 3515 indicates an end point of the iterative process beginning at step 3502. If step 3523 determines that the element is a block end element, the last line is set to the current line number (3524). Next, the in-block flag is set to OFF (3525). Next, control returns to step 3502 to begin a new iteration. Step 3515 indicates an end point of the iterative process beginning at step 3502. If step 3517 determines that the description is a related description, a new related item is added to the relation list of the currently processed record (3518). Next, the relation type is read (3519). Next, the currently processed new related item is set to the relation type (3520). Next, the related name label is read (3521). Next, the relation destination ID of the currently processed new related item is temporarily set to the related name label (3522), and control proceeds to step 3523. Finally, following step 3515, a relation destination ID setting process is performed on the relation list (3516).

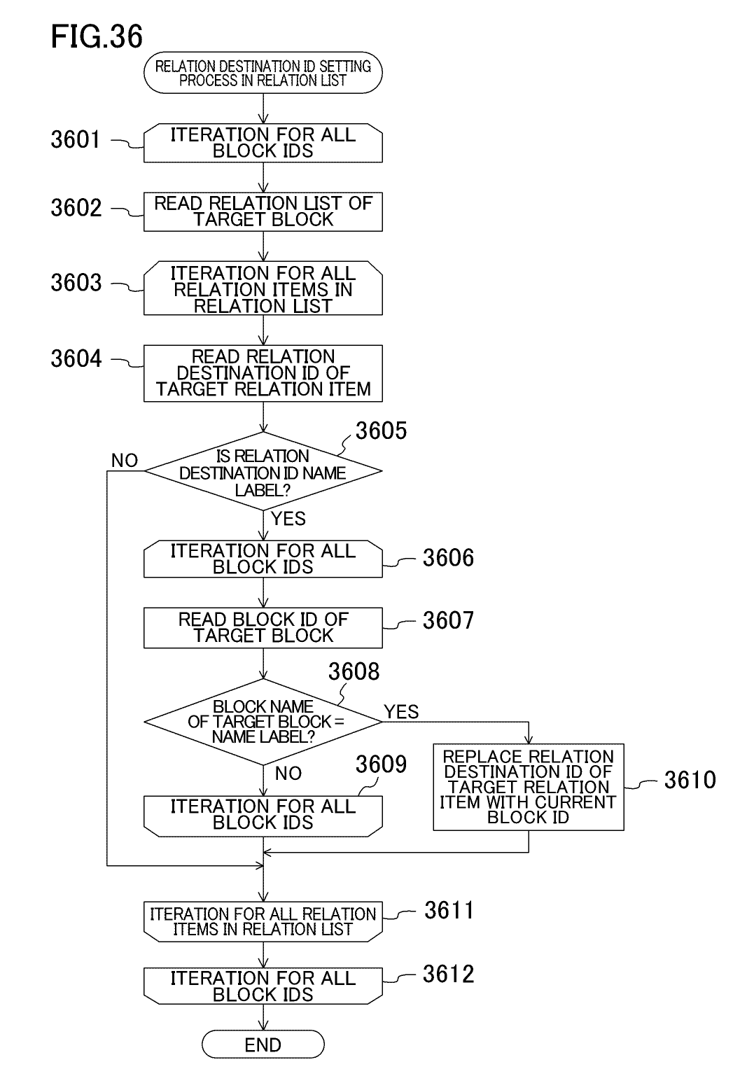

FIG. 36 shows a process flow of a relation destination ID setting subroutine on a relation list, which is called in step 3516 from the process flow of the source code reader 112 of FIG. 35. Initially, an iterative process is started for all block IDs (3601). Next, the relation list of a target block is read (3602). Next, an iterative process is started for all related items in the relation list (3603). Next, the relation destination ID of a target related item is read (3604). Next, it is determined whether or not the relation destination ID is a name label (3605). If the relation destination ID is not a name label, control returns to step 3603 to begin a new iteration. Step 3611 indicates an end point of the iterative process beginning at step 3603. If step 3605 determines that the relation destination ID is a name label, an iterative process is started for all block IDs (3606). Next, the block ID of a target block is read (3607). Next, it is determined whether or not the block name of the target block match the name label (3608). If the block name of the target block does not match the name label, control returns to step 3606 to begin a new iteration. Step 3609 indicates an end point of the iterative process beginning at step 3606. If step 3608 determines that the block name of the target block matches the name label, the relation destination ID of the target related item is replaced with the block ID (3610). Next, control returns to step 3603 to begin a new iteration. Step 3611 indicates an end point of the iterative process beginning at step 3603. Step 3612 indicates an end point of the iterative process beginning at step 3601.

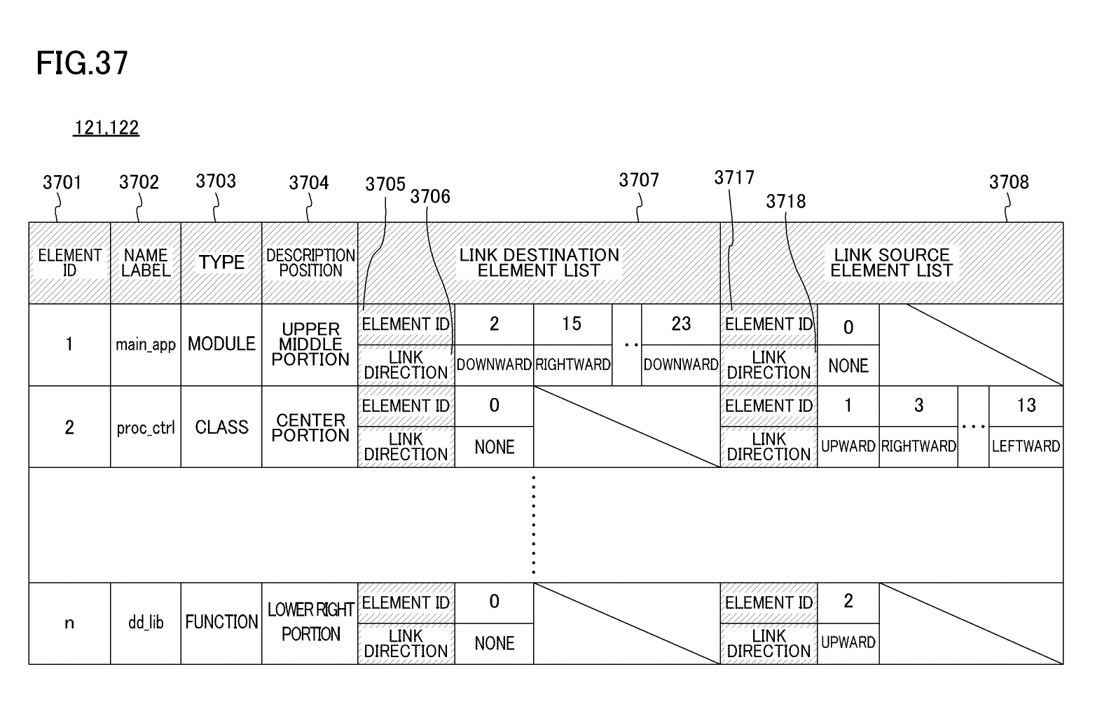

FIG. 37 shows software model information used as the initial software model information 121 or the generated software model information 122. The software model information 121, 122 includes an element ID 3701 which is the serial number of an element contained in a software model, a name label 3702 which is given to the element, a type 3703 which is the description type of the element, a description position 3704 which indicates a position where the element is described, a link destination element list 3707 which indicates a link from the element to another element, and a link source element list 3708 which indicates a link from another element to the element. The link destination element list 3707 includes an element ID 3705 indicating a link destination element and a link direction 3706 indicating the direction of the link. The link source element list 3708 includes an element ID 3717 indicating a link source element which is linked from another element, and a link direction 3718 indicating a link direction itself. Note that if there is no link destination or link source, “0” is stored in the corresponding field. As an example, a case is shown where the element ID is “n,” the name label is “dd_lib,” the type is “function,” the description position is “lower right portion,” the element ID in the link destination element list “0,” the link direction of the link destination element list is “none,” the element ID of the link source element list is “2,” and the link direction of the link source element list is “upward.”

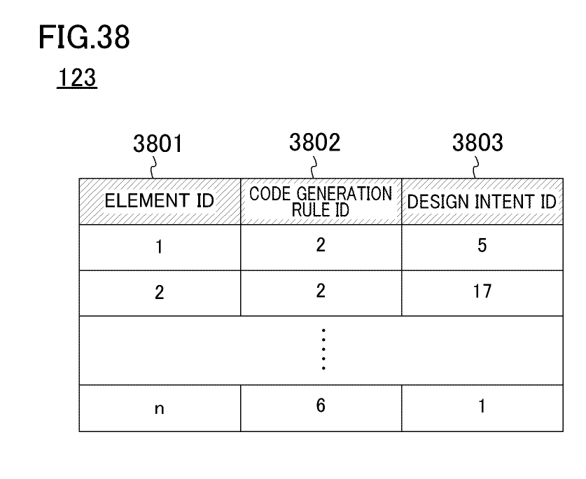

FIG. 38 shows the software model design intent information 123. The software model design intent information 123 includes an element ID 3801 for identifying an element described in a software model, a code generation rule ID 3802 for identifying a code generation rule, and a design intent ID 3803 for identifying data of design intent. As an example, a case is shown where the element ID is “n,” the code generation rule ID is “6,” and the design intent ID is “1.”

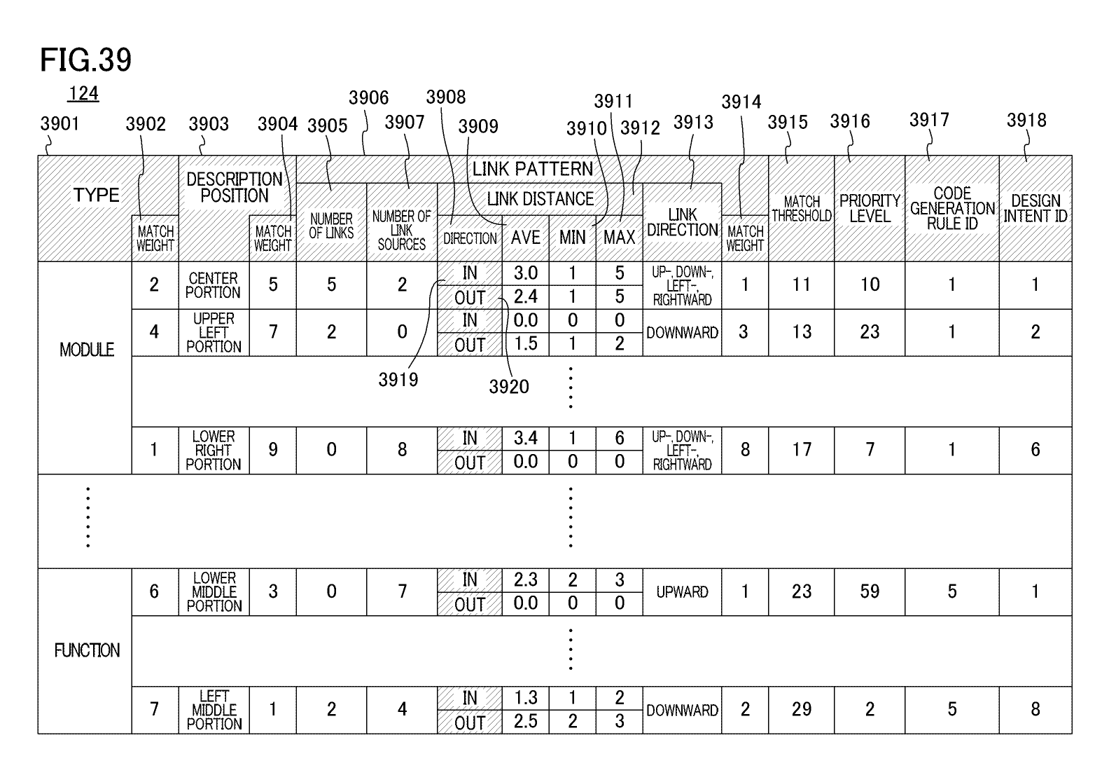

FIG. 39 shows the software model design intent extraction rule information 124. The software model design intent extraction rule information 124 includes a type 3901 which indicates a type of an element described in a software model, a description position 3903 which indicates a description position of the element described in the software model, a link pattern 3906 in which a link pattern of the element described in the software model is quantified, a match threshold 3915 which is a threshold for determining that the rule matches a software model design intent extraction rule, a priority level 3916 which indicates a priority level when a plurality of similar rules match, a code generation rule ID 3917 for identifying a code generation rule, and a design intent ID 3918 for identifying design intent. The link pattern 3906 includes the number of links 3905 which indicates the number of other elements to which a corresponding element is linked, the number of link sources 3907 which indicates the number of other elements which are linked to the element, a link distance 3912 which indicates a distance of each link, and a link direction 3913 which indicates a link direction between elements. The link distance 3912 has two fields, i.e., IN 3919 and OUT 3920, which depend on the link direction 3908. Each field includes an average link distance (AVE) 3909, a smallest link distance (MIN) 3910, and a greatest link distance (MAX) 3911. The type 3901, the description position 3903, and the link pattern 3906 each have match weights 3902, 3904, and 3914, respectively, for weighting conditions when the match determination is performed. As an example, a case is shown where the type is “function,” the match weight value of the type is “7,” the description position is “left middle portion,” the match weight value of the description position is “1,” the number of links of the link pattern is “2,” the number of link sources is “4,” the average distance in the incoming direction (IN) of the link distance “1.3,” the smallest value is “1,” the greatest value is “2,” the average distance in the outgoing direction (OUT) is “2.5,” the smallest value is “2,” the greatest value is “3,” the link direction is “downward,” the match weight value of the link pattern is “2,” the match threshold is “29,” the priority level is “2,” the code generation rule ID is “5,” and the design intent ID is “8.”

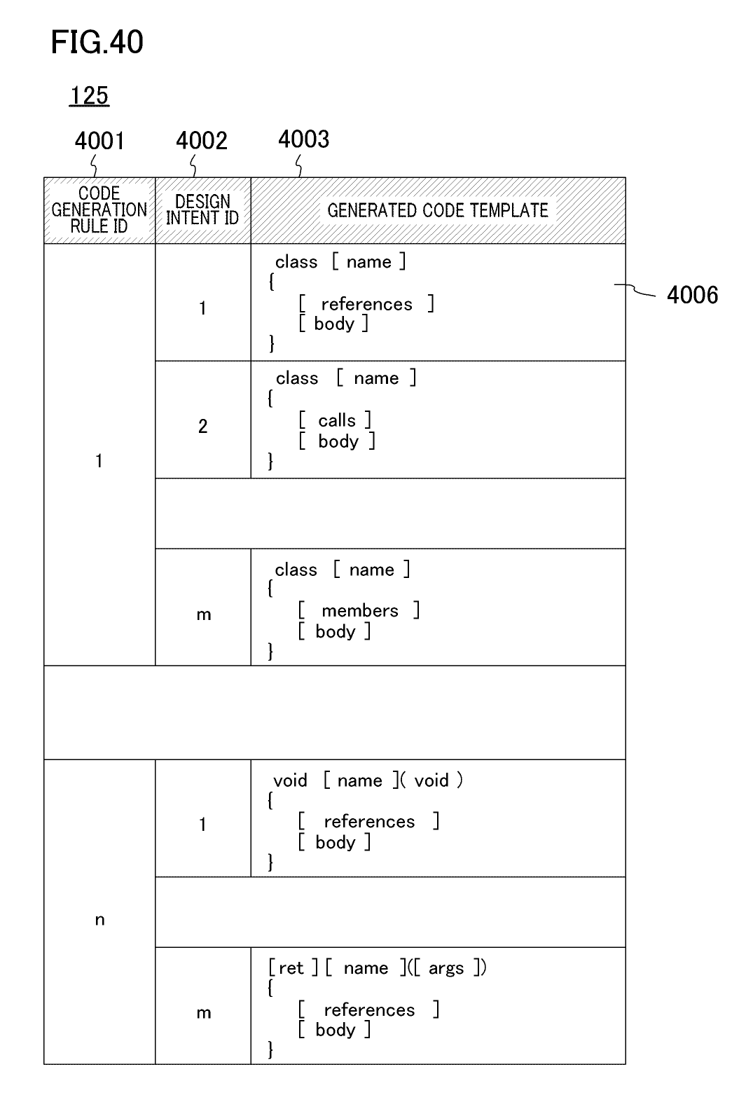

FIG. 40 shows the source code generation rule information 125. The source code generation rule information 125 is a table which stores information for converting an element described in a software model into a source code. The source code generation rule information 125 includes a code generation rule ID 4001 for identifying a code generation rule, a design intent ID 4002 for identifying a difference between generated codes which occurs due to a difference in developer's design intent even when the code generation rule is the same, and a generated code template 4003 which stores a template of a code which is output as a source code. As an example, a case is shown where the code generation rule ID is “1,” the design intent ID is “1,” and the generated code template is “class [name] {[reference] [body] }” (4006).

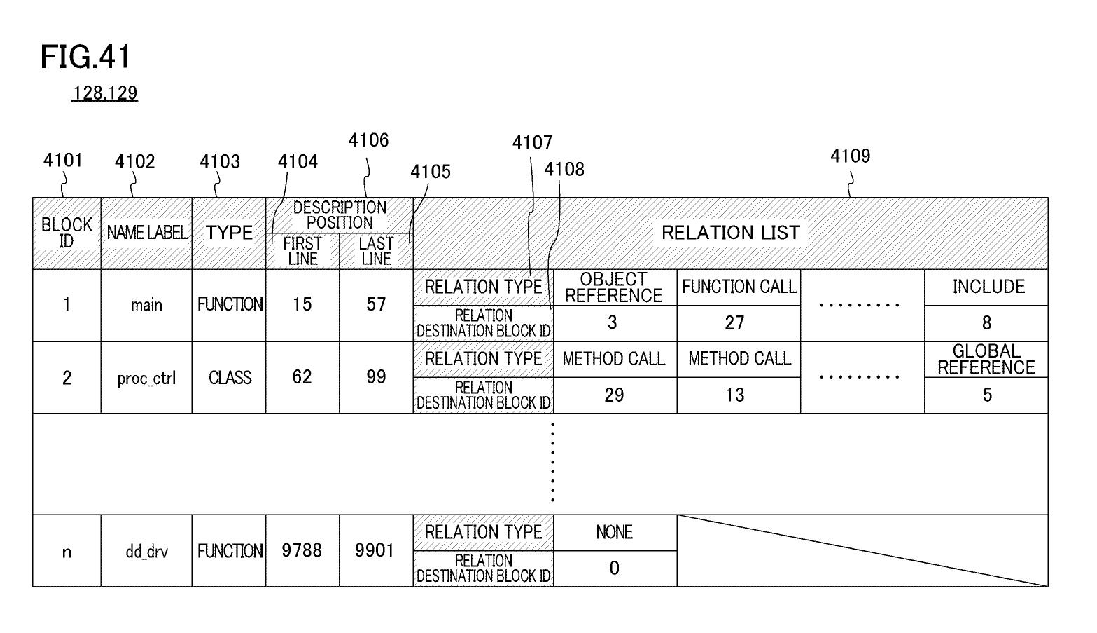

FIG. 41 shows source code information which is used as the regenerated source code information 128 or the modified source code information 129. The source code information 128, 129 includes a block ID 4101 which indicates a number for identifying a block in a source code, a name label 4102 which indicates a name (e.g., a function name) given to the block, a type 4103 which indicates a type of the block, a description position 4106 indicates a description position of the block in the source code, and a relation list 4109 which indicates a relation between the block and another block. The description position 4106 includes a first line 4104 which indicates the first line of the block, and a last line 4105 which indicates the last line of the block. The relation list 4109 includes a relation type 4107 which indicates a type of a relation destination block, and a relation destination block ID 4108 which indicates a block ID for identifying the relation destination block. Note that when there is no related block, the relation type 4107 in the relation list is set to “none,” and the relation destination block ID 4108 in the relation list is set to “0.” As an example, a case is shown where the block ID is “n,” the name label is “dd_drv,” the type is “function,” the first line of the description position is “9788,” the last line of the description position is “9901,” the relation type of the relation list is “none,” and the relation destination block ID of the relation list is “0.”

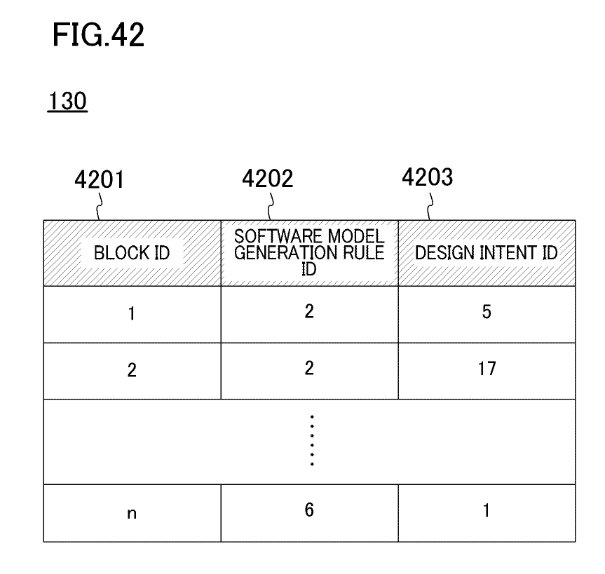

FIG. 42 shows the source code design intent information 130. The source code design intent information 130 includes a block ID 4201 for identifying a block which is described in a source code, a software model generation rule ID 4202 for identifying a generation rule of a software model based on the block of the source code, and a design intent ID 4203 for identifying data of design intent. As an example, a case is shown where the block ID is “n,” the software model generation rule ID is “6,” and the design intent ID is “1.”

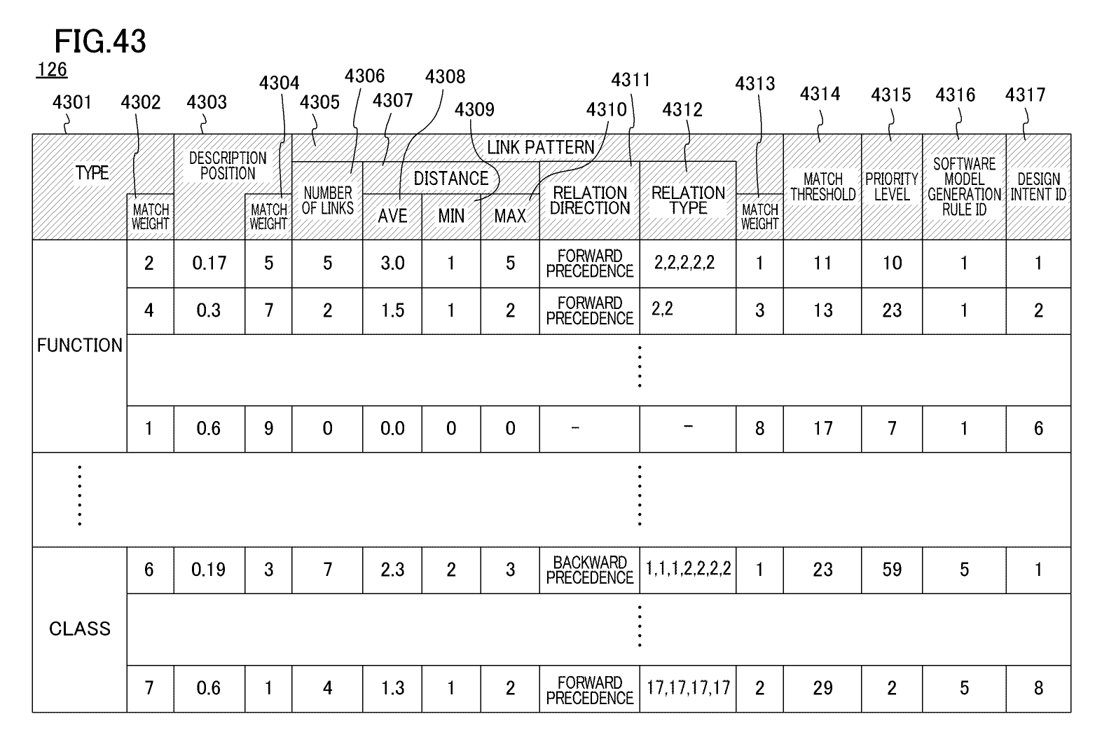

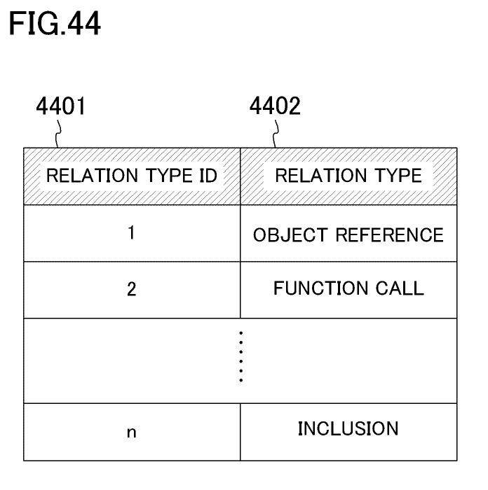

FIG. 43 shows the source code design intent extraction rule information 126. The source code design intent extraction rule information 126 includes a type 4301 for identifying a type of a block which is described in a source code, a description characteristic 4303 which indicates a characteristic of a description of the block described in the source code, a relation pattern 4305 which indicates a pattern of relation between the block and another block, a match threshold 4314 for determining that the rule matches the source code design intent extraction rule, a priority level 4315 which indicates a priority level when a plurality of similar rules match, a software model generation rule ID 4316 for identifying a software model generation rule, and a design intent ID 4317 for identifying design intent. The relation pattern 4305 includes the number of relations 4306 which indicates the number of other blocks to which the block is related, a distance 4307 which indicates a distance of each relation, a relation direction 4311 which indicates in which of the forward and backward directions a relation between blocks is stronger in the source code, and a relation type 4312 which is a list of numeric values converted from the types of relations using a relation type information table shown in FIG. 44. The distance 4307 of the relation pattern 4305 includes an average distance value (AVE) 4308, a smallest distance value (MIN) 4309, and a greatest distance value (MAX) 4310. The type 4301, the description characteristic 4303, and the relation pattern 4305 have match weights 4302, 4304, and 4313, respectively, for weighting conditions when the match determination is performed. As an example, a case is shown where the type is “class,” the match weight value of the type is “7,” the description characteristic is “0.6,” the match weight value of the description characteristic is “1,” the number of relations of the relation pattern is “4,” the average distance value of the relation pattern is “1.3,” the smallest distance value of the relation pattern is “1,” the greatest distance value of the relation pattern is “2,” the relation direction of the relation pattern is “forward precedence,” the relation type of the relation pattern is “17, 17, 17, 17,” the match weight value of the relation pattern is “2”, the match threshold is “29,” the priority level is “2,” the software model generation rule ID is “5,” and the design intent ID is “8.”

FIG. 44 shows a relation type information table used for the source code design intent extraction rule information 126. The relation type information table includes a relation type ID 4401 for identifying a relation type, and a relation type 4402 indicating the relation type itself. As an example, a case is shown where the relation type ID is “n,” and the relation type is “inclusion.”

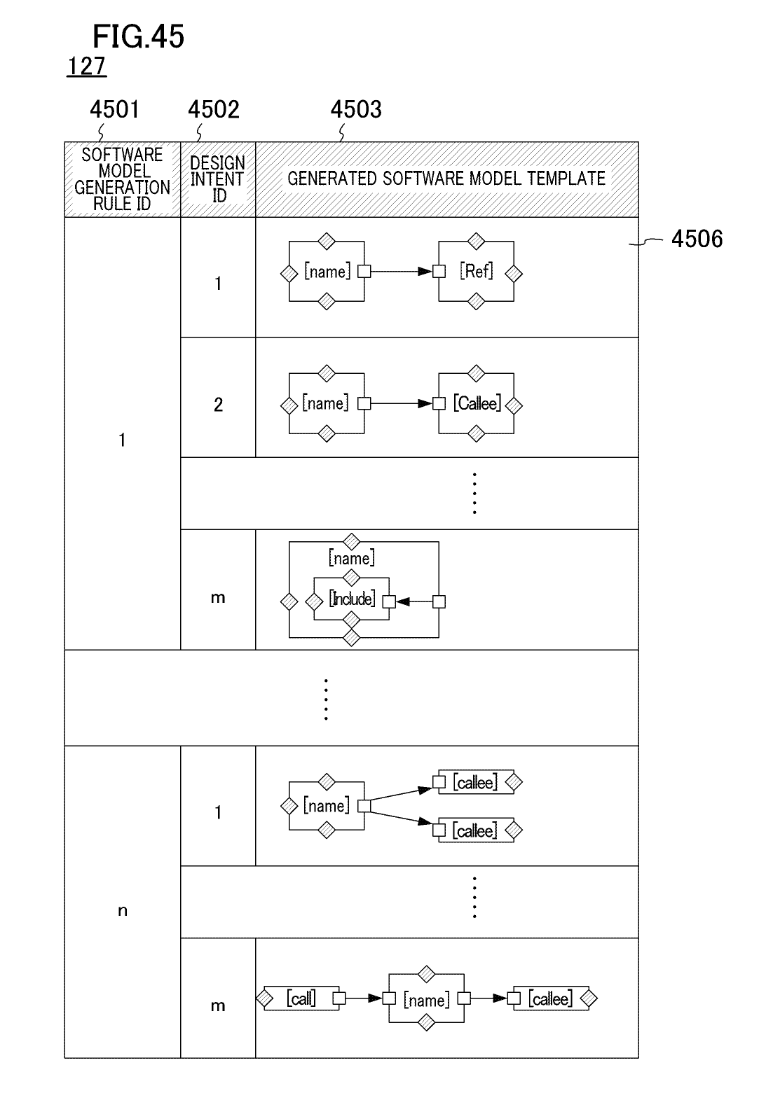

FIG. 45 shows the software model generation rule information 127. The software model generation rule information 127 is a table which stores information for converting a block described in a source code into a software model. The model generation rule information 127 includes a software model generation rule ID 4501 for identifying a software model generation rule, a design intent ID 4502 for identifying a difference between generated software models which occurs due to a difference in developer's design intent even when the software model generation rule is the same, and a generated software model template 4503 which stores a software model template which is output as a software model. As an example, a case is shown where the software model generation rule ID is “1,” the design intent ID is “1,” and the generated software model template is a picture (4506) shown in FIG. 44.

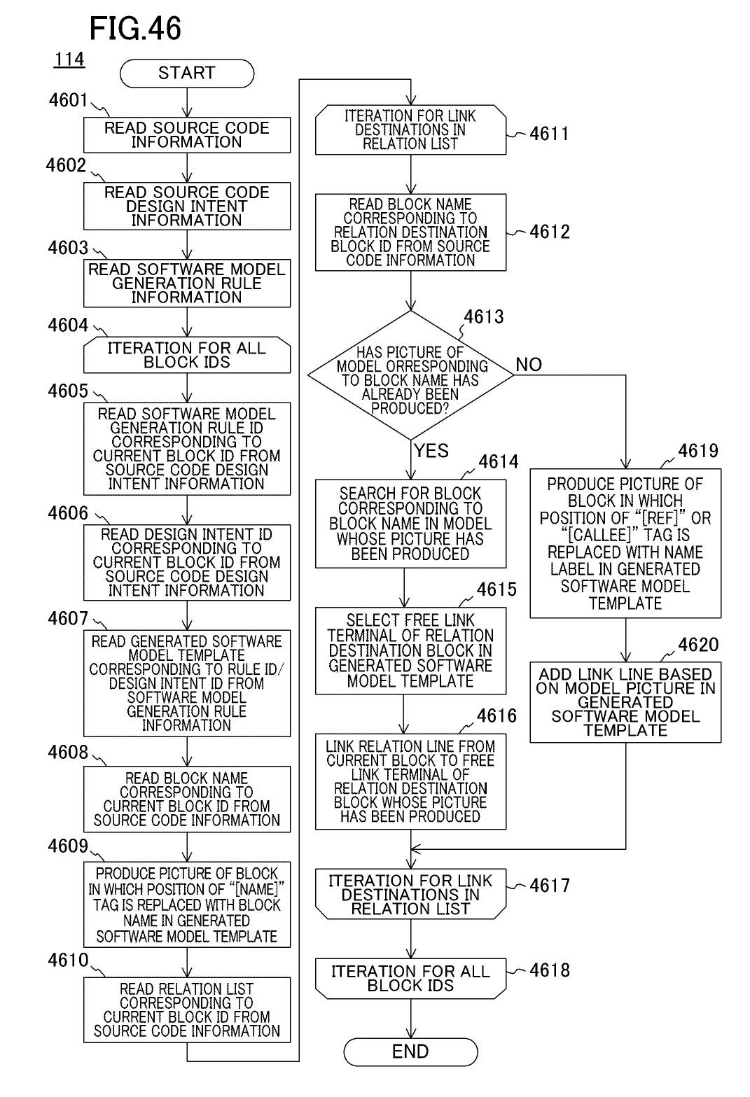

FIG. 46 shows a process flow of the software model generator 114. The software model generator 114 receives the modified source code information 129 or the regenerated source code information 128, the source code design intent information 130, and the software model generation rule information 127 which stores a rule for generating a software model, and outputs a generated software model 116 corresponding to the manually modified source code 120 or the regenerated source code 118.

Initially, the source code information 128 or 129 is read (4601). Next, the source code design intent information 130 is read (4602). Next, the software model generation rule information 127 is read (4603). Next, an iterative process is started for all block IDs (4604). Next, a software model generation rule ID corresponding to a current block ID is read from the source code design intent information 130 (4605). Next, a design intent ID corresponding to the current block ID is read from the source code design intent information 130 (4606). Next, a generated software model template corresponding to a rule ID/design intent ID is read from the software model generation rule information 127 (4607). Next, a block name corresponding to the current block ID is read from the source code information 128 or 129 (4608). Next, a picture of a block for which the position of the “[name]” tag in the generated software template is replaced with the block name is produced (4609). Next, a relation list corresponding to the current block ID is read from the source code information 128 or 129 (4610). Next, an iterative process is started for link destinations in the relation list (4611). Next, a block name corresponding to the relation destination block ID is read from the source code information 128 or 129 (4612). Next, it is determined whether or not a picture of a model corresponding to the block name has already been produced (4613). If a picture of a model corresponding to the block name has already been produced, a block corresponding to the block name is searched for in the model whose picture has been produced (4614). Next, a free link terminal of a relation destination block is selected based on the model picture in the generated software model template (4615). Next, a relation line is linked from the current block to the free link terminal of the relation destination block whose picture has been produced (4616). Next, control returns to step 4611 to begin a new iteration. Step 4617 indicates an end point of the iterative process beginning at step 4611. If step 4613 determines that a picture of a model corresponding to the block name has not yet been produced, a picture of a block in which the position of the “[Ref]” or “[callee]” tag is replaced with the name label in the position generated software model template is produced (4619). Next, a link line based on the model picture in the generated software model template is added (4620). Next, control returns to step 4611 to begin a new iteration. Step 4617 indicates an end point of the iterative process beginning at step 4611. Step 4618 indicates an end point of the iterative process beginning at step 4604.

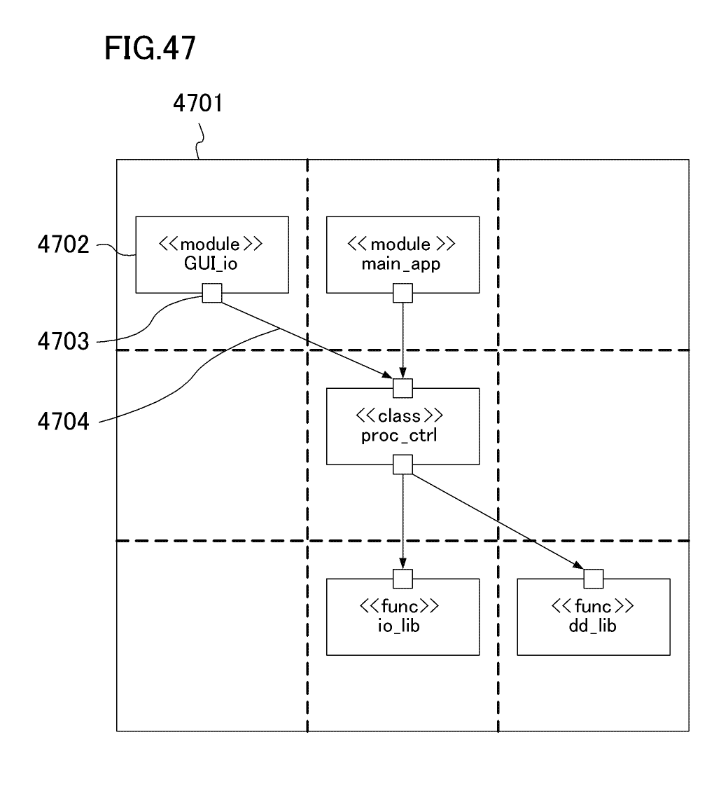

FIG. 47 shows an example software model. A reference character 4701 indicates an entire frame of the software model. A reference character 4702 indicates an element described in a software model. As an example, here, the stereotype is “module,” the name label is “GUI_io,” and the element is linked to another element “proc_ctrl” at a link port 4703 via a link line 4704. The element GUI_io has a description position which is “upper left portion.”

Note that the software model illustrated in this embodiment is based on UML. Alternatively, software models employing other graphic representations may be used. The generated source code is written in the C programming language or the C++ programming language in this embodiment. Alternatively, similar advantages can be obtained even if other programming languages are instead employed.

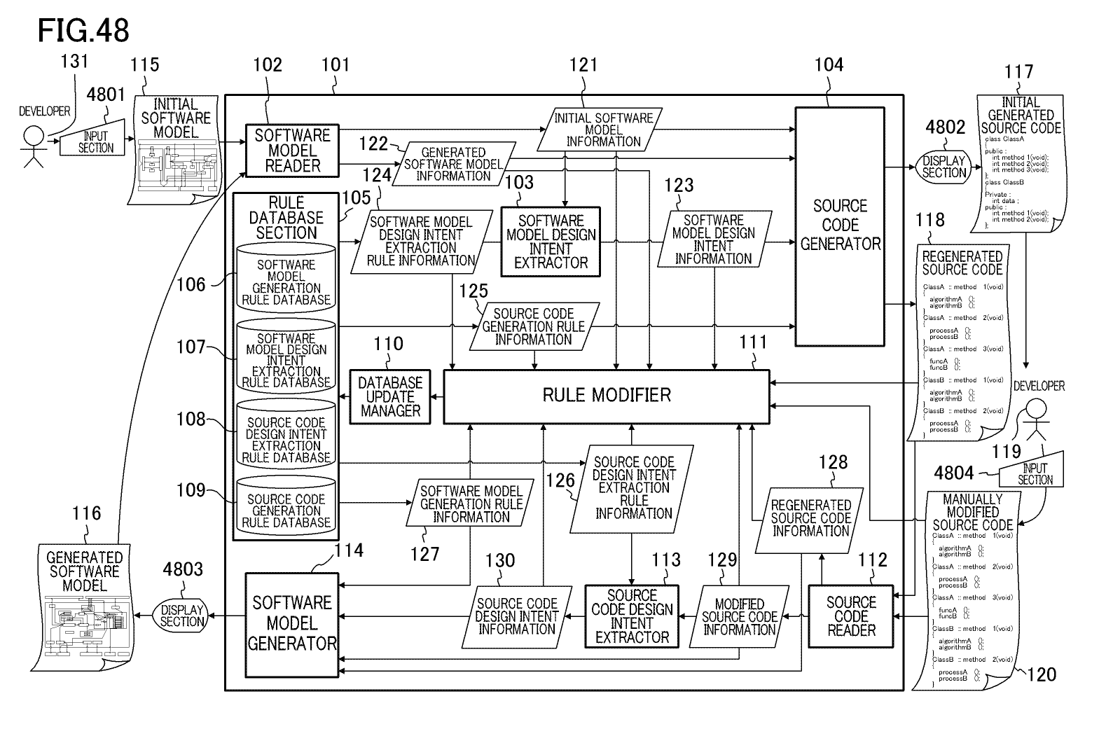

FIG. 48 is a configuration diagram of a system which includes the software development support tool 101 of the embodiment of the present disclosure and an input/output section. Here, a configuration is shown where the developer 131 directly inputs a software model via an input/output section 4801 to a computer system, and an automatically generated source code is displayed on a display device (display section) 4802. The developer 119 can directly input a source code via an input/output section 4804 to the computer system, and an automatically generated software model can be displayed on a display device (display section) 4803. Note that, instead of using the display devices 4802 and 4803, the software model may be printed out by a printer, may be read aloud by speech synthesis, etc. A document scanner, an image data input, etc. may be employed instead of the input/output sections 4801 and 4804.

According to the present disclosure, a software model is automatically generated from an existing source code. Therefore, a software model containing a software developer's design intent can be easily obtained even from a large-size source code. Therefore, the present disclosure can provide a software development support tool for the development of software mainly directed to software models, which contributes to an increase in the productivity of software and is widely and generally useful for software design.

What is claimed is:

1. A software development support tool comprising:
a software model reader configured to receive a software model described by a developer and output information required for automatic generation of a source code as software model information;
a software model design intent extractor configured to receive the software model information, and software model design intent extraction rule information which describes a rule for extracting design intent of the developer described in the software model, and extract and output the design intent of the developer described in the software model as software model design intent information; and
a source code generator configured to receive the software model information, the software model design intent information, and source code generation rule information which describes a rule for generating the source code from the software model, and output the source code.

2. A software development support tool comprising:
a source code reader configured to receive a source code described by a developer and output information required for automatic generation of a software model as source code information;
a source code design intent extractor configured to receive the source code information, and source code design intent extraction rule information which describes a rule for extracting design intent of the developer described in the source code, and extract and output the design intent of the developer described in the source code as source code design intent information; and
a software model generator configured to receive the source code information, the source code design intent information, and software model generation rule information which describes a rule for generating the software model from the source code, and output the software model.

3. The software development support tool of claim 1, further comprising:
a source code reader configured to receive a source code and output information required for automatic generation of a software model as source code information;
a source code design intent extractor configured to receive the source code information, and source code design intent extraction rule information which describes a rule for extracting design intent of the developer described in the source code, and extract and output the design intent of the developer described in the source code as source code design intent information; and
a software model generator configured to receive the source code information, the source code design intent information, and software model generation rule information which describes a rule for generating the software model from the source code, and output the software model.

4. The software development support tool of claim 3, further comprising:
a rule database section configured to accumulate, in a database, the software model generation rule information, the software model design intent extraction rule information, the source code generation rule information, and the source code design intent extraction rule information, and manage the database;
a database update manager configured to manage updating of contents of the rule database section; and
a rule modifier configured to receive the software model information, the software model generation rule information, the software model design intent extraction rule information, the software model design intent information, the source code information, the source code generation rule information, the source code design intent extraction rule information, and the source code design intent information, and instruct the database update manager to modify the software model generation rule information, the software model design intent extraction rule information, the source code generation rule information, and the source code design intent extraction rule information to reflect intent of the developer.

5. The software development support tool of claim 1, wherein
as the software model information, an element ID, a name label, a type, a description position, a link destination element list, and a link source element list are provided in order to represent a characteristic of the software model.

6. The software development support tool of claim 1, wherein
as the software model design intent information, an element ID, a code generation rule ID, and a design intent ID are provided in order to relate an element described in the software model to the design intent of the developer.

7. The software development support tool of claim 1, wherein
as the software model design intent extraction rule information, a type, a description position, a link pattern, a match threshold, a priority level, a code generation rule ID, and a design intent ID are provided in order to characterize the design intent of the developer.

8. The software development support tool of claim 1, wherein
as the source code generation rule information, a code generation rule ID, a design intent ID, and a generated code template are provided in order to store information for generating a source code which reflects the design intent of the developer.

9. The software development support tool of claim 7, wherein
the software model design intent extractor determines whether or not there is a match with the software model design intent extraction rule information, using a type of an element or elements described in the software model, a description position of the element or elements, a link pattern between the element or elements, which are represented as the software model information.

10. The software development support tool of claim 7, wherein
a match weight value is provided for each of the type, description position, and link pattern of the software model design intent extraction rule information, and
the software model design intent extractor extracts design intent which is easily reflected in develop intent of a designer by performing match determination to search for software model design intent information which matches the design intent of the developer while weighting the type, the description position, and the link pattern.

11. The software development support tool of claim 2, wherein
as the source code information, a block ID, a name label, a type, a description position, and a relation list are provided in order to represent a characteristic of the source code.

12. The software development support tool of claim 2, wherein
as the source code design intent information, a block ID, a software model generation rule ID, and a design intent ID are provided in order to relate a block described in the source code to the design intent of the developer.

13. The software development support tool of claim 2, wherein
as the source code design intent extraction rule information, a type, a description characteristic, a relation pattern, a match threshold, a priority level, a software model generation rule ID, and a design intent ID are provided in order to characterize description intent of the developer.

14. The software development support tool of claim 2, wherein
as the software model generation rule information, a software model generation rule ID, a design intent ID, and a generated software model template are provided in order to generate the software model in which description intent of the developer is reflected.

15. The software development support tool of claim 13, wherein
the source code design intent extractor determines whether or not there is a match with the source code design intent extraction rule information, using a type of a block or blocks described in the source code, a description characteristic of the block or blocks, and a relation pattern between the block or blocks, which are represented as the source code information.

16. The software development support tool of claim 15, wherein
the source code design intent extractor obtains the description characteristic used in the determination of whether or not there is a match with the source code design intent extraction rule information, from a first line of the block, a last line of the block, and the number of relations of the block.

17. The software development support tool of claim 13, wherein
a match weight value is provided for each of the type, description characteristic, and link pattern of the source code design intent extraction rule information, and
the source code design intent extractor extracts design intent which is easily reflected in develop intent of a designer by performing match determination to search for source code design intent information which matches the design intent of the developer while weighting the type, the description characteristic, and the link pattern.

18. The software development support tool of claim 3, wherein
a software model developed by the developer for the first time is input as an initial software model instead of the software model, the source code output by the software development support tool is defined as an initial generated source code, and a manually modified source code obtained by the developer manually modifying the initial generated source code is input as the source code of the software development support tool, and a generated software model is output instead of the software model.

19. The software development support tool of claim 18, wherein
the initial software model and the generated software model are input to output a regenerated source code, thereby outputting the source code in which the design intent of the developer is reflected to a greater extent than that of the initial generated source code.

20. The software development support tool of claim 19, wherein
the regenerated source code is input to automatically generate a regenerated software model, thereby reflecting the design intent of the developer to a greater extent.

21. The software development support tool of claim 18, wherein
the initial software model is input to the software model reader, and initial software model information is output by the software model reader instead of the software model information, thereby distinguishing the initial software model obtained by the developer from the automatically generated software model.

22. The software development support tool of claim 19, wherein
the generated software model is input to the software model reader, and generated software model information is output by the software model reader instead of the software model information, thereby outputting the regenerated source code from the automatically generated software model.

23. The software development support tool of claim 18, wherein
the manually modified source code is input to the source code reader, and modified source code information is output by the source code reader instead of the source code information, thereby distinguishing the source code already modified by the developer from the automatically generated source code.

24. The software development support tool of claim 19, wherein
the regenerated source code is input to the source code reader, and regenerated source code information is output by the source code reader instead of the source code information, thereby outputting the generated software model from the regenerated source code.

25. The software development support tool of claim 4, wherein
the rule modifier adds a new source code generation rule to the source code generation rule information based on a difference between modified source code information and regenerated source code information.

26. The software development support tool of claim 4, wherein
the rule modifier finds out a modified portion of the source code generation rule information based on a difference between a modified source code and a regenerated source code, modified source code information, and regenerated source code information, and modifies a generation source code template contained in the source code generation rule information.

27. The software development support tool of claim 4, wherein
the rule modifier adds a new software model generation rule to the software model generation rule information based on a difference between initial software model information and generated software model information.

28. The software development support tool of claim 4, wherein
the rule modifier finds out a modified portion of the software model generation rule information based on a difference in link destination between elements described in an initial software model and a generated software model, initial software model information, and generated software model information, and modifies a generated software model template contained in the software model generation rule information.

29. A software development support system comprising:
the software development support tool of claim 1;
an input section configured to input a software model from a developer to the software development support tool; and
a display section configured to display a source code generated by the source code generator.

30. A software development support system comprising:
the software development support tool of claim 2;
an input section configured to input a source code from a developer to the software development support tool; and
a display section configured to display a software model generated by the software model generator
